(19) United States
(12) Patent Application Publication
(10) Pub. No.: US 2013/0239003 A1
(43) Pub. Date: Sep. 12, 2013

(54) DIGITAL ALBUM PRODUCTION AND DISTRIBUTION ARCHITECTURE

(71) Applicants: DANIL USENKO, SEATTLE, WA (US); OLEKSANDR PRYKHODKO, EVERETT, WA (US); SERGEY LOMAKIN, SNOHOMISH, WA (US)

(72) Inventors: DANIL USENKO, SEATTLE, WA (US); OLEKSANDR PRYKHODKO, EVERETT, WA (US); SERGEY LOMAKIN, SNOHOMISH, WA (US)

(73) Assignee: TOUCHALBUMS LLC, SEATTLE, WA (US)

(21) Appl. No.: 13/413,482

(22) Filed: Mar. 6, 2012

(51) Int. Cl. G06F 3/041; G06F 3/048

(52) U.S. Cl. 715/733; 715/752; 715/741

(57) ABSTRACT

Digital album production and distribution architectures are disclosed, including a production node configured to produce digital albums, a distribution server node configured to receive, store and distribute digital albums as well as additional album-related content, and a client node configured to view and interact with digital albums.

### BACKGROUND

Professionally produced photo albums for life events such as weddings and graduations are designed to be engaging visual experiences that capture and express enduring memories of the event. Professionals often expend significant time and effort in making the album, and the album reflects the photographer's skill and artistry.

Today, many people are accustomed to sharing photos via the internet, and in general, professional photographers have accommodated internet photo sharing by providing clients with photos in digital as well as physical form. Knowing that an album is more than the sum of its constituent photos, some professional photographers may go a step further and provide clients with an entire album in digital form. However, adequate tools for professional production and distribution of digital albums are lacking in the industry. As a result, digital albums may be of varying quality in terms of the features they incorporate, and digital albums may be distributed with varying degrees of polished professionalism. There is a need in the industry for a digital album production and distribution architecture that enables professional photographers to create appealing, full featured digital album products, and to distribute digital albums with a high degree of professionalism.

### SUMMARY

Digital album production and distribution technologies are disclosed. Some example digital album production and distribution architectures may comprise: a production node configured to produce digital albums, a distribution server node configured to receive, store and distribute digital albums as well as additional album-related content, and/or a client node configured to view and interact with digital albums. An example production node may include a computer configured with digital album production software to create digital albums and publish the digital albums to a distribution server node. The production node may be operable by a professional photographer, while the distribution server node may be operable by a distributor/intermediary. An example distribution server node may include a server configured to receive digital albums from one or more production nodes, store the digital albums, distribute the digital albums to one or more client nodes, and distribute additional album-related content to one or more client nodes. A client node may be operable by customers of the professional photographer as well as the customer's friends and relations. An example client node may comprise a client computing device such as a smart phone, tablet computer, laptop or other form of computer, configured with album viewing and interaction software to retrieve digital albums from the distribution server node, interact with the digital albums, and/or share the digital albums and additional album-related content with a distribution server node and/or one or more additional client nodes. Some embodiments may comprise a production node, a distribution server node, or a client node alone, corresponding computer readable media and/or methods performed thereby, when such node is configured to provide one or more of the various features disclosed herein. Some embodiments may comprise a digital album product, e.g., a computer readable media configured with digital album files that incorporate one or more of the various features disclosed herein.

### BRIEF DESCRIPTION OF THE DRAWINGS

FIG. 1 illustrates an example digital album production and distribution architecture.

FIG. 2 illustrates aspects of example devices within the digital album production and distribution architecture.

FIG. 3 illustrates an example production node User Interface (UI).

FIG. 4 illustrates an example production node UI.

FIG. 5 illustrates an example production node UI.

FIG. 6 illustrates an example production node UI.

FIG. 7 illustrates an example production node UI.

FIG. 8 illustrates an example production node UI.

FIG. 9 illustrates an example production node UI.

FIG. 10 illustrates an example production node UI.

FIG. 11 illustrates an example production node UI.

FIG. 12 illustrates an example production node UI.

FIG. 13 illustrates an example production node UI.

FIG. 14 illustrates example aspects of a digital album production and distribution architecture directed to ordering prints, and corresponding methods.

FIG. 15 illustrates an example client node UI.

FIG. 16 illustrates an example client node UI.

FIG. 17 illustrates an example client node UI.

FIG. 18 illustrates an example client node UI.

FIG. 19 illustrates an example client node UI.

FIG. 20 illustrates an example client node UI.

FIG. 21 illustrates an example client node UI.

FIG. 22 illustrates an example client node UI.

FIG. 23A illustrates an example client node UI.

FIG. 23B illustrates an example client node UI.

FIG. 24 illustrates an example client node UI.

FIG. 25 illustrates an example display sequence indicating navigation between pages of a digital album.

FIG. 26 illustrates an example client node UI.

FIG. 27 illustrates an example client node UI.

FIG. 28 illustrates an example client node UI.

FIG. 29 illustrates an example client node UI.

FIG. 30 illustrates an example client node UI.

FIG. 31 illustrates an example client node UI.

FIG. 32 illustrates an example client node UI.

FIG. 33 illustrates an example client node UI.

FIG. 34 illustrates an example client node UI.

FIG. 35 illustrates an example client node UI.

### DETAILED DESCRIPTION

The illustrative embodiments provided herein are not meant to be limiting. Other embodiments may be utilized, and changes may be made, without departing from the spirit or scope of the subject matter presented here. It will be understood that aspects of the present disclosure may be arranged, substituted, combined, and designed in a wide variety of different configurations.

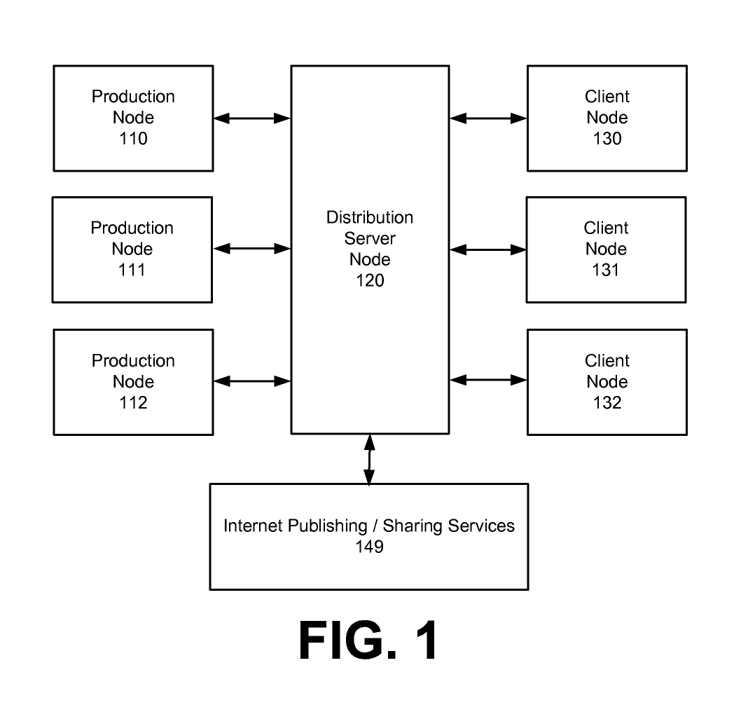

FIG. 1 illustrates an example digital album production and distribution architecture in accordance with various embodiments of this disclosure. The digital album production and distribution architecture includes one or more production nodes 110, 111, 112, configured to produce digital albums and album distribution information, and configured to provide digital albums and album distribution information to a distribution server node 120. The distribution server node 120 is configured to receive digital albums and album distribution information from one or more production nodes 110, 111, 112, and configured to provide digital albums to one or more client nodes 130, 131, 132 according to the album distribution information. The distribution server node 120 may also be configured to provide digital albums to internet publishing/sharing services 149 according to the album distribution information. The client nodes 130, 131, 132 are configured to receive, view, and optionally interact with digital albums. Interactions such as commenting on an album guestbook may produce additional album-related content, which may be received and stored at the distribution server node 120, and which may also be distributed to the one or more client nodes 130, 131, 132 and/or internet publishing/sharing services 149 according to the album distribution information.

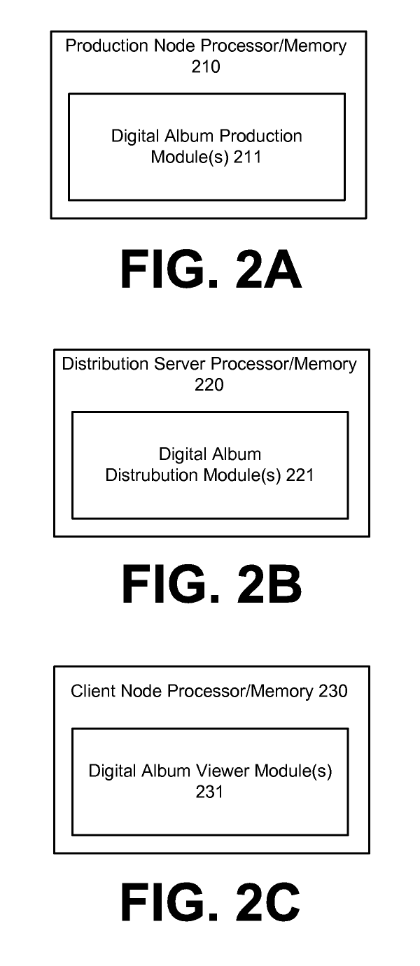

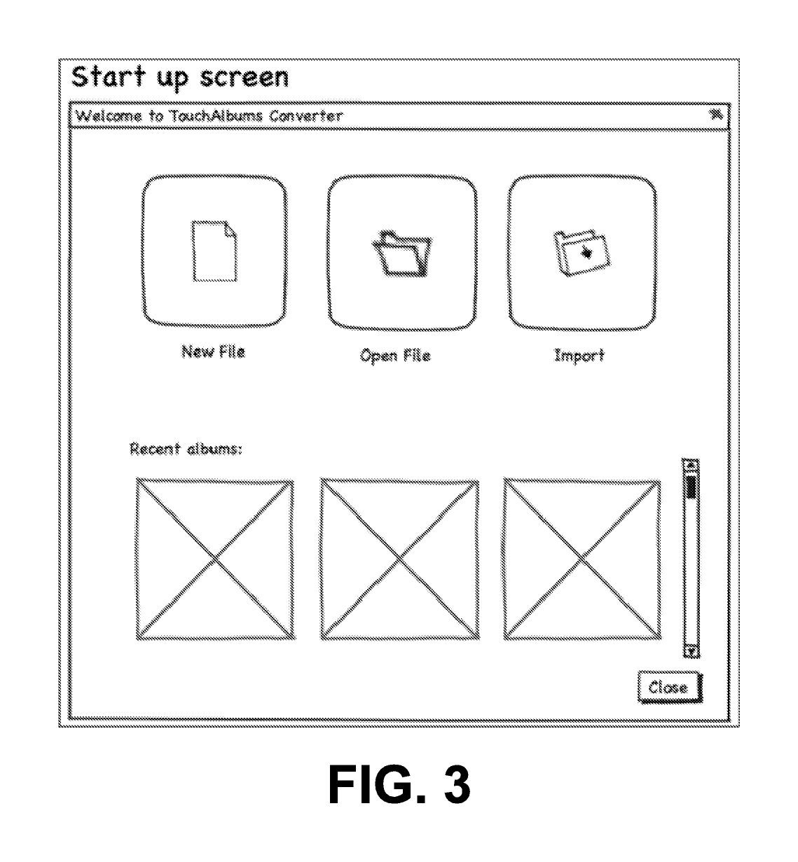

In some embodiments the one or more production nodes 110, 111, 112 may be configured with a processor/memory 210 comprising digital album production modules 211 as illustrated in FIG. 2. Various features that may be provided by a production node 110 are disclosed in detail in FIGS. 3-13 and corresponding description. Among the features that may be provided by a production node 110 are: digital album client manager controls, design controls, branding controls, and expression controls. The client manager controls may generate album distribution information for a digital album. The design controls and branding controls may be configured to generate album content, layout, and branding. Album content may include, inter alia, images such as digital photographs and/or other visual content including digital artwork and designs. The expression controls may generate album page-level and image-level interaction permission settings for sharing via social media, saving on a client device, emailing, and/or commenting, and may also generate zoom properties for album spreads and individual digital images included therein. These and other example features of a production node 110 are disclosed in detail in connection with FIGS. 3-13.

In some embodiments, the distribution server node 120 may be configured to receive digital albums and album distribution information from one or more production nodes 110, 111, 112, and configured to distribute digital albums to one or more client nodes 130, 131, 132 and/or to internet publishing/sharing services 149 according to the received distribution information. The distribution server node 120 may be configured to automatically notify to one or more client nodes 130, 131, 132, e.g., by sending an email, when a digital album is ready for viewing. The distribution server node 120 may then control access to a digital album by, for example, requiring a password or other credential for digital album access. The distribution server node 120 may also be configured to receive additional album-related content, for example guest book entries, from the one or more client nodes 130, 131, 132, store the additional album-related content, and/or distribute the additional album-related content to one or more client nodes 130, 131, 132 and/or to internet publishing/sharing services 149 according to the received distribution information.

In some embodiments, the distribution server node 120 may be configured to provide digital album production modules 211 (see FIG. 2), e.g., digital album production software and software updates, to the production nodes 110, 111, 112. The distribution server node 120 may also be configured to provide digital album viewer modules 231 (see FIG. 2), e.g., digital album viewer software and software updates, to the client nodes 130, 131, 132 and/or to an application distribution server configured to update the client nodes 130, 131, 132.

In some embodiments, the distribution server node 120 may be configured to validate and/or modify received digital albums prior to distribution to the client nodes 130, 131, 132. For example, the distribution server node 120 may be configured to validate that received digital albums do not contain any malware or viruses, and do contain predefined desired properties, such as by including predefined album metadata and/or fitting certain album format specifications. The distribution server node 120 may be configured to notify a production node 110 in the event of a validation error. The distribution server node 120 may also be configured to modify received digital albums by inserting metadata, removing unnecessary metadata, and/or adjusting album properties to meet predefined size, format, and/or other criteria. In some embodiments, the distribution server node 120 may be configured to convert a received digital album into a digital album that is optimized for viewing by a client node in the form of a mobile device, wherein the mobile device includes application software (an “app”) configured to retrieve digital albums from the distribution server node 120 and display the retrieved digital albums.

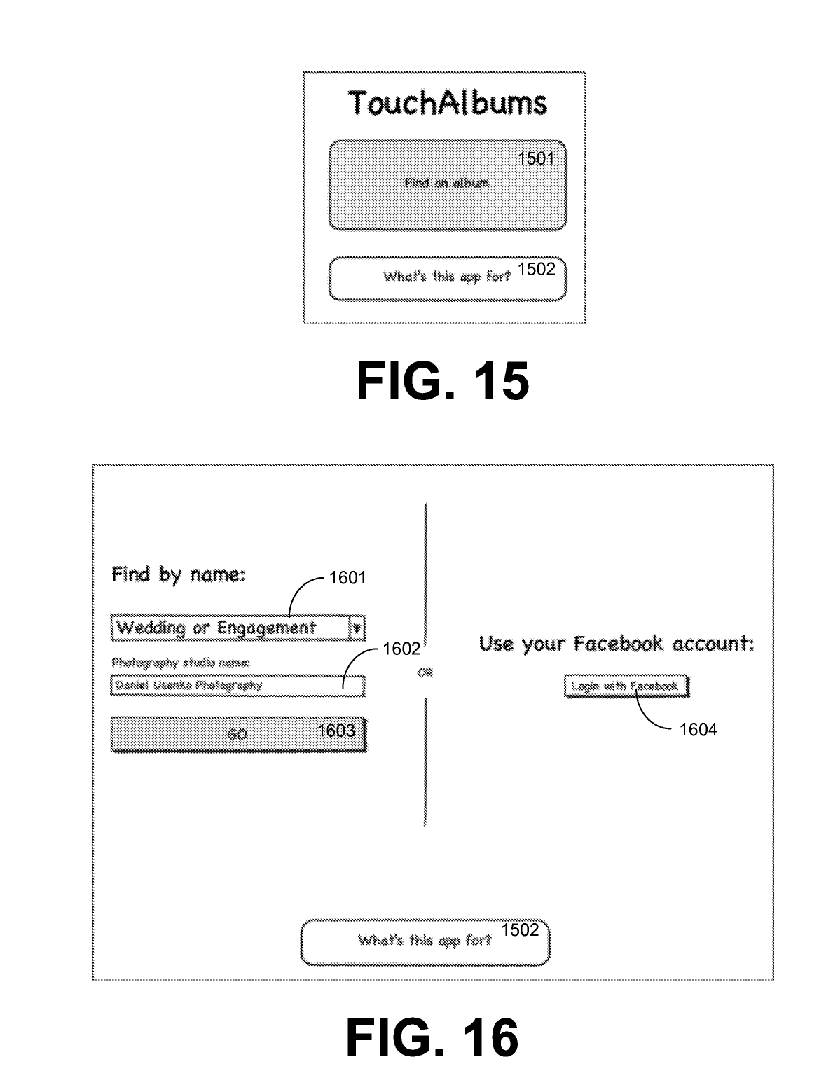

In some embodiments, the one or more client nodes 130, 131, 132 may comprise mobile computing devices such as IPHONE®, IPAD®, ANDROID® or WINDOWS MOBILE® type mobile devices. A digital album viewer application (an “app) may be distributed to the client nodes 130, 131, 132, e.g., from the distribution server node 120 and/or from an application marketplace server such as provided by the APPLE® computer company for its IPHONE® and IPAD® devices, as well as by GOOGLE® for its ANDROID® devices. Client nodes 130, 131, 132 configured with the digital album viewer application may connect to the distribution server node 120, establish access permissions for album viewing, receive a digital album from the distribution server node 120, and display corresponding digital albums. Client nodes 130, 131, 132 configured with the digital album viewer application may also interact with digital albums, when digital album properties set at a production node 110 allow, e.g., by ordering prints from an album, sharing a digital album, album pages, and/or album images via social media websites, locally saving a digital album, album pages, and/or album images, emailing a digital album, album pages, and/or album images, and/or commenting on a digital album, album pages, and/or album images, or generating an album guest book entry. These and other example features of a client node 130 are disclosed in detail in connection with FIGS. 15-35.

FIG. 2 illustrates aspects of example devices within the digital album production and distribution architecture in accordance with various embodiments of this disclosure. FIG. 2A illustrates an example production node processor/memory 210 comprising digital album production modules 211. The production nodes 110, 111, 112 of FIG. 1 may be equipped with a production node processor/memory 210 according to FIG. 2A. FIG. 2B illustrates an example distribution node processor/memory 220 comprising digital album distribution modules 221. The distribution server node 120 of FIG. 1 may be equipped with a distribution server node processor/memory 220 according to FIG. 2B. FIG. 2C illustrates an example client node processor/memory 230 comprising digital album viewer modules 231. The client nodes 130, 131, 132 of FIG. 1 may be equipped with a client node processor/memory 230 according to FIG. 2A.

In some embodiments, the digital album production modules 211, digital album distribution modules 221, and digital album viewer modules 231 may be stored on computer readable media. The modules 211, 221, 231 may also configure corresponding devices to present UI described herein, and to carry out methods in accordance with this disclosure.

FIG. 3-FIG. 13 illustrate example production node UI in accordance with various embodiments of this disclosure. In general, the production node UI may be used to produce digital album files, including any of the properties thereof discussed herein. Digital album files may be distributed via the distribution server node 120 to client nodes such as 130. The client nodes may be configured via album viewer modules 231 to view and interact with the digital album files produced using the production node.

In general, digital album files produced using the production node may comprise, inter alia, an album cover, one or more album spreads (also referred to as pages), and a guestbook. The album cover may comprise for example one or more cover images, at defined positions on the album cover. The album spreads may also comprise one or more images at defined positions on the album spreads. The guestbook may comprise fields configured to receive guest names and comments on the album and the event documented thereby.

Digital album files may also comprise properties that activate and deactivate interaction controls available when viewing a digital album with a client node. Example interaction controls may include interaction controls pertaining to individual selected images within an album, such as an order prints control, a share image control, an email image control, and a save image control. In some embodiments, digital album properties may activate and deactivate interaction controls for each image in an album, e.g., allowing different interaction controls for different images. In some embodiments, digital album properties may activate and deactivate interaction controls globally for all images in an album. Example interaction controls may also include interaction controls pertaining to an album as a whole, such as an order album control, a share album control, an email album control, and a save album control.

As described in further detail with respect to the client node, digital album files may be produced using the production node may be touch-interactive. That is, digital album files may be configured in view of touch interactions with digital albums at the client node. The production node may optionally assign certain touch interaction properties to a digital album, and touch interaction properties may be optionally also be applied by the distribution server and/or client nodes.

FIG. 3 illustrates an example production node UI in accordance with various embodiments of this disclosure. FIG. 3 provides a start up screen comprising selectable controls, including a “new file” control, an “open file” control, and an “import” control. FIG. 3 also includes a plurality of selectable “recent album” controls, which may comprise album cover thumbnail images.

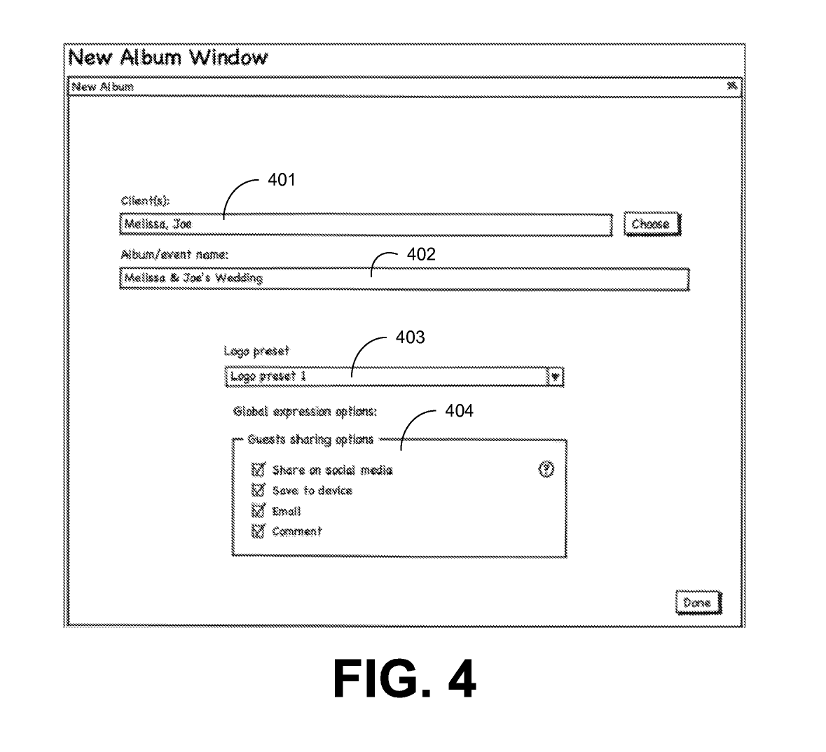

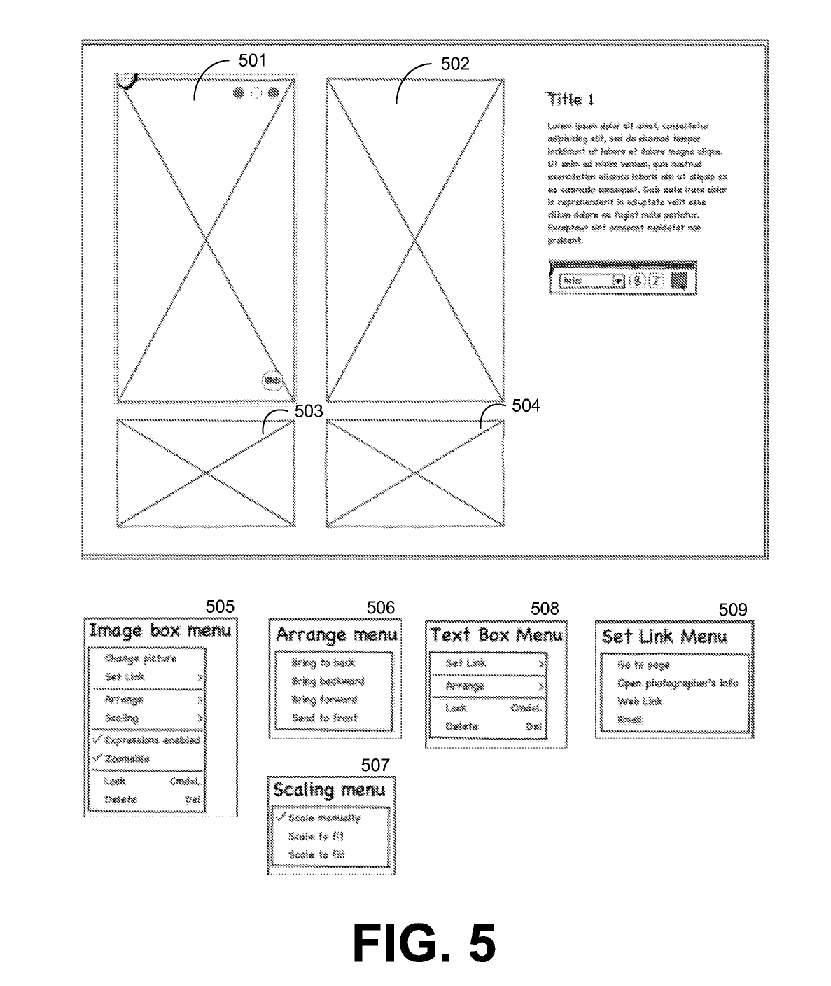

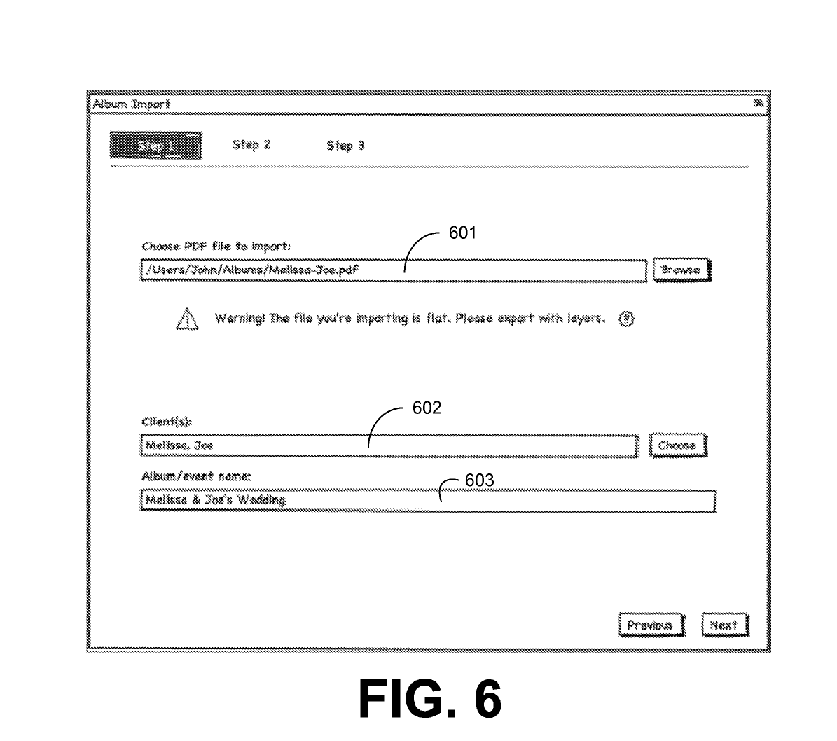

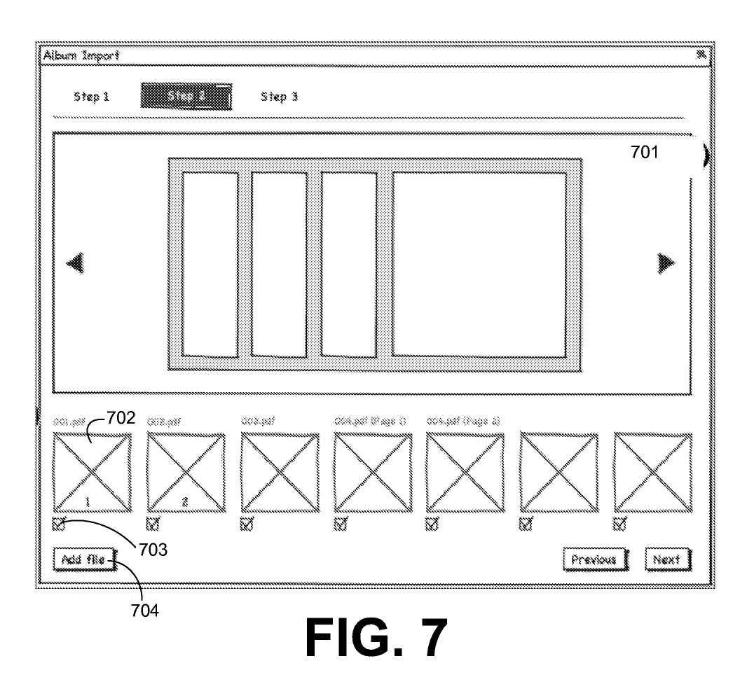

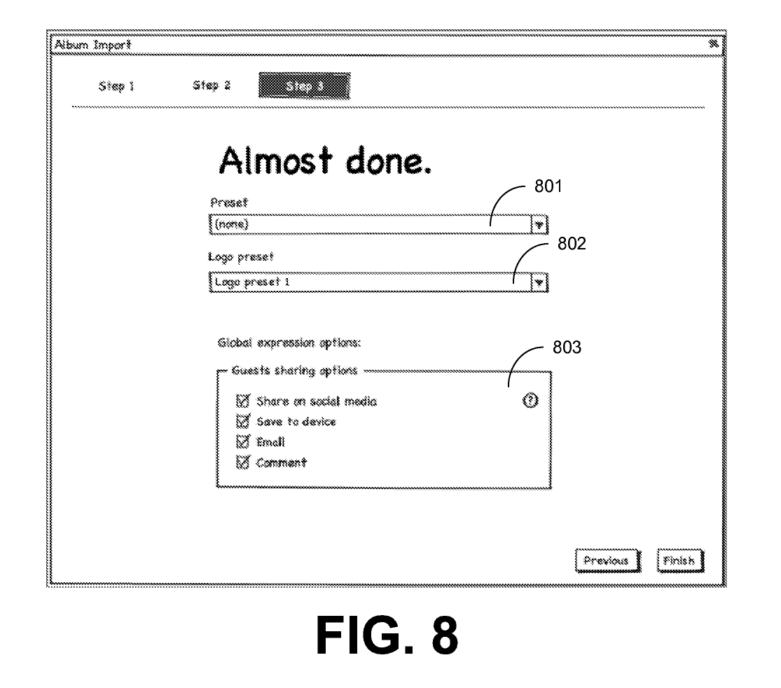

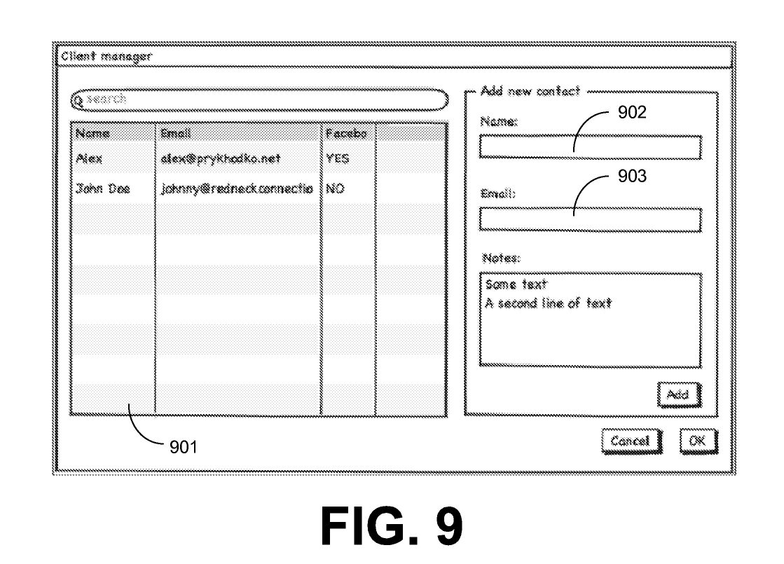

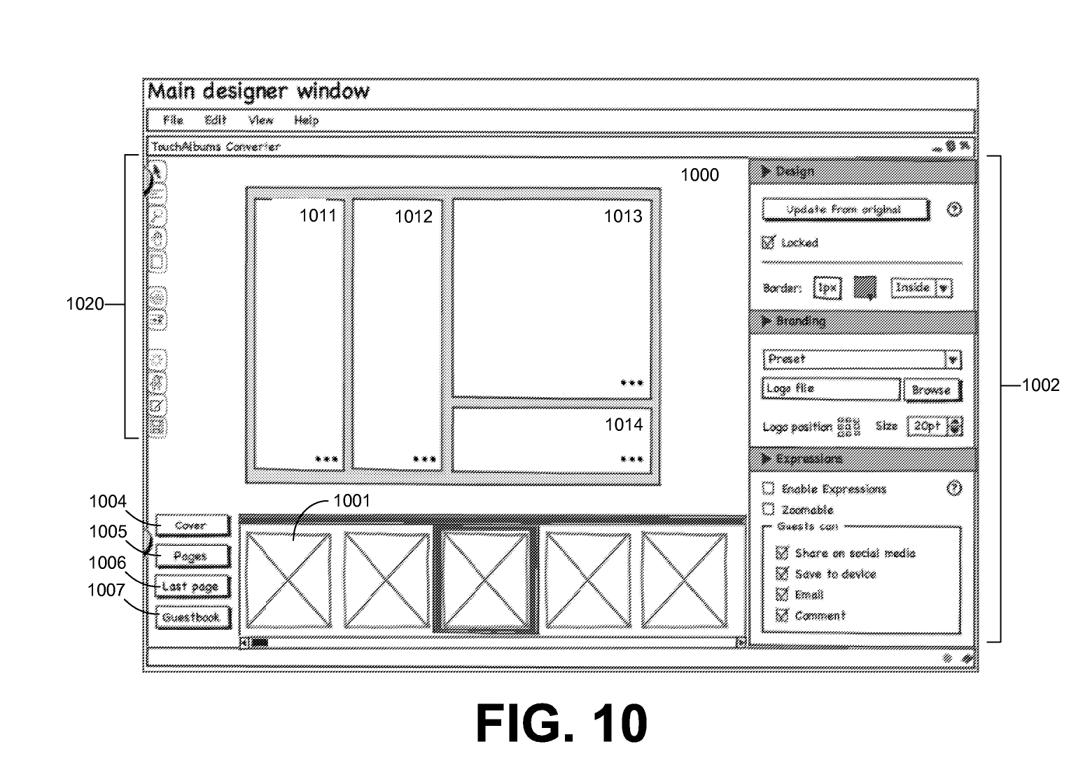

Digital album production modules 211 may be configured to respond to selection of the “new file” control in FIG. 3 by presenting a UI such as FIG. 4, followed by FIG. 9, FIG. 5, and FIG. 10. Digital album production modules 211 may be configured to respond to selection of the “open file” control in FIG. 3, or any of the “recent album” controls by presenting a UI such as FIG. 10. Digital album distribution modules 221 may be configured to respond to selection of the “import” control in FIG. 3 by presenting a UI such as FIG. 6, followed by FIG. 7, FIG. 8, FIG. 9, and FIG. 10.

FIG. 4 illustrates an example production node UI in accordance with various embodiments of this disclosure. FIG. 4 provides a new album UI, comprising a client selection field 401, an album/event name field 402, a logo preset field 403, and one or more selectable/deselectable global expression controls 404.

Digital album production modules 211 may be configured to receive a client identifier via the client selection field 401 in FIG. 4, and to assign the client identifier to a new album. Digital album production modules 211 may be configured to respond to selection of the “choose” control in FIG. 4 by providing a client manager UI, such as illustrated in FIG. 9.

Referring briefly to FIG. 9, the illustrated client manager UI may be configured to display a client identifier list 901, and to receive a client identifier selection from the list 901. The client manager UI may also be configured to receive new client identifiers and associated digital album distribution information, e.g., client email(s) and/or social network distribution information, via fields 902 and 903. Digital album production modules 211 may be configured to add received new client identifiers and associated digital album distribution information to the client identifier list.

Referring back to FIG. 4, digital album production modules 211 may be configured to receive an album/event name via the album/event name field 402, and to assign the received album/event name to a new album.

Digital album production modules 211 may be configured to receive a logo preset selection via the logo preset field 403 in FIG. 4, and to receive one or more global expression selections via the selectable/deselectable global expression controls 404. Digital album production modules 211 may be configured to apply a logo to a new album according to the logo preset selection, and to apply image permissions globally to all images of a new album according to the global expression selections. In some embodiments, the applied logo(s) and/or expression selections can optionally be changed after the new album file is created. In some embodiments, digital album production modules 211 may be configured to present one or more UI such as illustrated in FIG. 5 after receiving the various new album information from the UI illustrated in FIG. 4.

FIG. 5 illustrates an example production node UI in accordance with various embodiments of this disclosure. FIG. 5 includes a new album content selection and layout UI and a plurality of control menus. The content selection and layout UI may include, e.g. a plurality of images 501, 502, 503, 504 (illustrated as rectangles bisected in both directions by diagonal lines) and text. The control menus 505-509 may include, e.g., an image box menu 505, an arrange menu 506, a scaling menu 507, a text box menu 508, and a set link menu 509. Each of the control menus 505-509 may provide a plurality of controls, and the digital album production modules 211 may be configured to receive, inter alia, image selections, image properties, text selections and text properties, and image and text layout commands, via the various control menus 505-509. In some embodiments, digital album production modules 211 may be configured to present a UI such as illustrated in FIG. 10 after receiving new album new album content selection and layout information from one or more UI such as illustrated in FIG. 5.

FIG. 6 illustrates an example production node UI in accordance with various embodiments of this disclosure. FIG. 6 includes a first album import UI, comprising an album selection field 601, a client selection field 602, and an album/event name field 603. The client selection and album/event name fields 602, 603 may comprise fields configured as described above in connection with FIG. 4. Digital album production modules 211 may be configured to receive an album file location via the album selection field 601 in FIG. 6. Digital album production modules 211 may be configured to provide a UI such as FIG. 7 after FIG. 6.

FIG. 7 illustrates an example production node UI in accordance with various embodiments of this disclosure. FIG. 7 includes a second album import UI, comprising an album page preview window 701, a plurality selectable album page thumbnails such as 702, a plurality of album page selection/deselection controls such as 703, and an “add file” control 704.

Digital album production modules 211 may be configured to receive an album page selection from among the plurality selectable album page thumbnails 702, and to display the selected album page in the album page preview window 701. Digital album production modules 211 may be configured to provide “next page” and “previous page” controls in the album page preview window, and to display a next/previous album page in the album page preview window 701 in response to receiving a next page/previous page selection.

Digital album production modules 211 may be configured to include album pages which are selected with the plurality of album page selection/deselection controls 703 in an imported album, and not to include album pages which are deselected.

Digital album production modules 211 may be configured to provide a UI including an album selection field, e.g., similar to the album selection field 601 in FIG. 6, in response to receiving a selection of the “add file” control 704. In response to receiving an additional album file location, the digital album production modules 211 may be configured to include pages from an additional selected album among the plurality selectable album page thumbnails 702 in FIG. 7, allowing selection/deselection of album pages from multiple original album files, and corresponding inclusion of album pages from multiple original album files, within an imported album.

FIG. 8 illustrates an example production node UI in accordance with various embodiments of this disclosure. FIG. 8 includes a third album import UI, comprising a preset selection field 801, a logo preset selection field 802, and one or more selectable/deselectable global expression controls 803. The fields and controls of FIG. 8 are also illustrated in FIG. 4 and may provide similar functions, namely, applying a logo and image permissions to an imported album and the various images therein, according to received selections.

Digital album production modules 211 may be configured to respond to selection of a “finish” control in FIG. 8 by creating an imported the album file from the albums identified via FIG. 6 and/or FIG. 7, the imported the album file comprising only the album pages selected via FIG. 7. The imported the album file may comprise the image content and layout properties of the album file(s) at the original album file location(s). The imported the album file may comprise or be associated with the received client identifier and album/event name received via FIG. 6. The imported the album file may comprise logo and global expression properties according to the selections received via FIG. 8.

FIG. 10 illustrates an example production node UI in accordance with various embodiments of this disclosure. FIG. 10 includes a main designer window UI, comprising, inter alia, an album page design work area 1000, shown in the main section of the UI, a plurality of selectable album page thumbnails such as 1001, shown along the bottom of the UI, and a plurality of album controls 1002, shown in the column on the right side of the UI.

Digital album production modules 211 may be configured to receive an album page selection from among the plurality selectable album page thumbnails 1001, and to display the selected album page in the album page design work area 1000. Also, controls such as the “cover” control 1004, “pages” control 1005, “last page” control 1006, and “guest book” control 1007, shown at bottom left of FIG. 10, may operate to jump to selection of pre-identified selectable album page thumbnails. FIG. 10 shows an album page comprising four rectangular boxes 1011, 1012, 1013, 1014 in the album page design work area 1000. Each box represents an image on the album page. Properties may be set for the entire album page displayed in the album page design work area 1000 using the album controls 1002. Individual images on an album page such as 1011, 1012, 1013, 1014 may also be selected from within the album page design work area 1000, and may be deleted, repositioned, and resized within the album page design work area 1000, and properties may be set for the individual images 1011, 1012, 1013, 1014 using the album controls 1002. FIG. 10 also provides a plurality of quick-access controls 1020 along the left hand side of the album page design work area. The quick-access controls 1020 may provide convenient access to controls configured for album page design, content selection, or any of the various controls disclosed herein.

In some embodiments, a main designer window UI such as illustrated in FIG. 10 may be configured to allow repositioning the images 1011, 1012, 1013, 1014 in 2 dimensions (2D) and/or 3 dimensions (3D). Repositioning in 2D may comprise for example changing a position of an image along the x and/or y axis of the album page design work area, e.g. by selecting and dragging an image to a desired location. The album page design work area 1000 may also comprise a z axis, allowing for displaying images at different “depths” within a digital album page. Repositioning may also comprise changing orientation of an image with respect to an album page. For example, an orientation of an image may be changed by rotating the image 90 and/or 180 degrees, or any other rotation angle.

With regard to repositioning in 3D, a main designer window UI may be configured, for example, to display a z-coordinate UI for an image, in response to receiving an image selection from within the album page design work area 1000. The user may then modify the z-coordinate of a selected image via the z-coordinate UI. Digital album production modules 211 may be configured to encode received z-coordinate data in a digital album file, allowing digital albums to be viewed in 3D by devices supporting 3D viewing.

Configuring a digital 3D album with images having a plurality of different z-coordinates with respect to an album page should be distinguished from configuring a digital album including 3D images. Both 2D and 3D digital albums, as those terms are used herein, may include 2D and/or 3D images. In a 2D album, the images, whether 2D or 3D, are all displayed on a same plane, e.g., a plane having a single z-coordinate. In a 3D album, the images, whether 2D or 3D, are displayed on a plurality of different planes, e.g., planes having several different z-coordinates. A production node may be configured to produce 2D and/or 3D albums, including 2D and/or 3D images. To produce an album including 3D images, a production node may be configured to import image files containing 3D image data, for example, image files that include two different images shot at two separate angles to correspond to the viewing angles of the two human eyes, and to configure a 3D images in a digital album using the 3D image data so that the 3D images appears in 3D.

In some embodiments, digital album production modules 211 may be configured to produce touch-interaction information for an album cover, album spreads, and/or album guestbook, and to include the touch-interaction information in one or more digital album files. Touch-interaction information may comprise, for example, a “meta-file” comprising locations of various touch-interactive areas and optionally identifying actions to take when such touch interactive area is selected. For example, each image on a spread can be designated as touch-interactive area. An action to take when an image is selected may comprise, e.g., individually displaying the selected image. In some embodiments, touch-interactive areas may be assigned a type identifier, and digital album viewer modules 231 may take an action when a touch interactive area is selected based on the type identifier. Any of the controls or other interactive properties of a digital album disclosed herein may be implemented by assigning a touch-interactive area to the control or area designated for touch-interactive input.

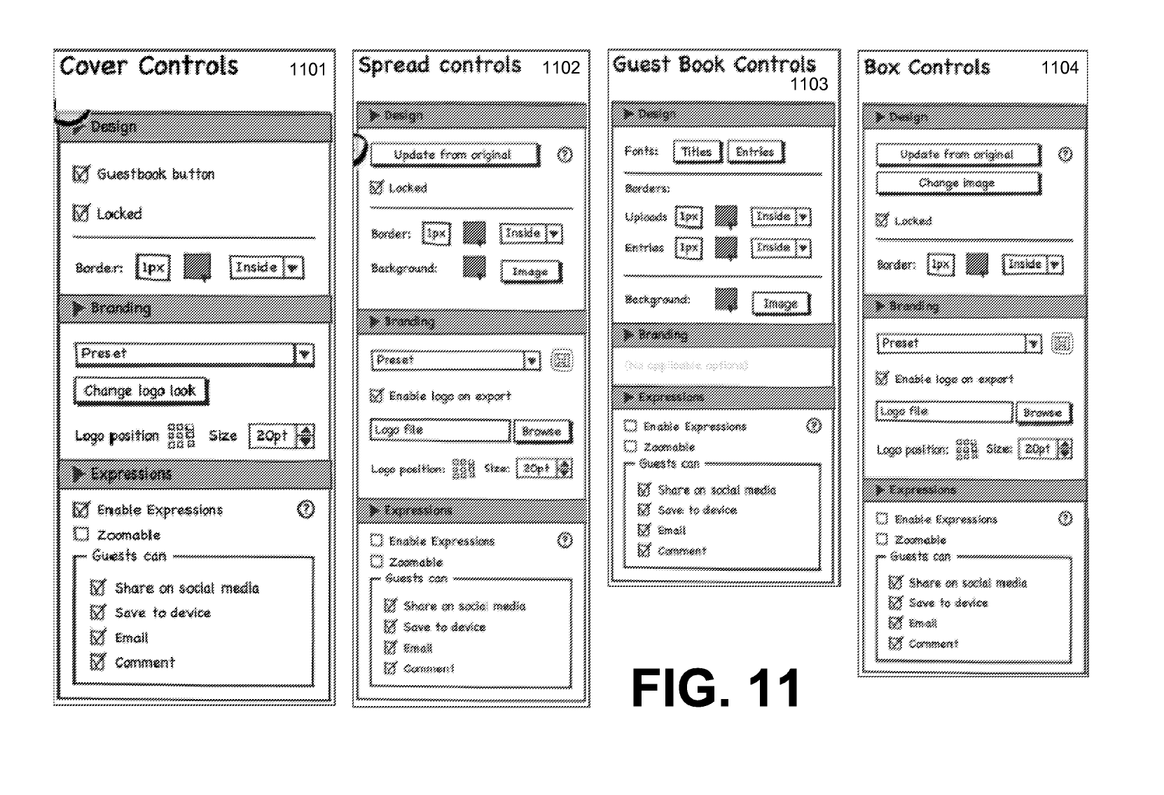

In some embodiments, digital album production modules 211 may be configured to automatically display a set of album controls 1002 that is appropriate for the album page and/or user selection within the album page design work area 1000. For example, referring to FIG. 11, if the album page displayed in the album page design work area 1000 is the album cover, then the cover controls 1101 may be displayed in the album controls area 1002—such as in the right side column of FIG. 10. If the album page displayed in the album page design work area 1000 is an internal album page, referred to as a spread, then the spread controls 1102 may be displayed in the album controls area 1002. If the album page displayed in the album page design work area 1000 is a guest book page, then the guest book controls 1103 may be displayed in the album controls area 1002. If an individual image 1012 is selected within the album page design work area 1000, then the box controls 1104 may be displayed in the album controls area 1002.

FIG. 11 illustrates an example production node UI in accordance with various embodiments of this disclosure. FIG. 11 includes four sets of album controls. Digital album production modules 211 may be configured to include one or more of the sets of album controls from FIG. 11 in the UI of FIG. 10, in response to a user selection, from within FIG. 10, of an album cover, album spread page, guest book page, or individual image.

The album cover controls 1101 may comprise design controls, branding controls, and expressions controls, as shown. The design controls may include a selectable/deselectable guest book button control, a selectable/deselectable lock control, and border property fields. The branding controls may include a branding preset selection field, a change logo look control, and logo positioning controls. The expressions controls may include a selectable/deselectable enabling expressions control, and/or a selectable/deselectable zooming control.

In response to a user selection of the guest book button control, digital album production modules 211 may be configured to toggle between enabling/disabling a guestbook shortcut button on a digital album cover. A guestbook shortcut button directs a viewer of a digital album to an album guestbook configured to receive names and comments entered by viewers of the album, e.g., viewers that view the album with a device configured with digital album viewer modules 231.

In response to a user selection of the lock control, digital album production modules 211 may be configured to toggle between enabling/disabling user repositioning and reorienting, within the album page design work area, of images included in an album cover.

In response to a user selection to enable expressions, digital album production modules 211 may be configured to respond to selection/deselection of a plurality of permission options, applicable when the digital album is viewed with the digital album viewer modules 231. The permission options may include, e.g., permitting guests to share the digital album as a whole on social media, permitting guests to save the digital album as a whole to a local device, permitting guests to email the digital album as a whole, and/or permitting guests to comment on the digital album as a whole. In response to a user selection of any of the plurality of permission options, the digital album production modules 211 may be configured to set corresponding permission settings for the digital album as a whole. In some embodiments, digital album production modules 211 may be configured to share a digital album as a whole on social media by sharing an invitation to view the digital album on social media, rather than exporting a digital album file itself to a social media web server. In some embodiments the invitation may comprise for example an album cover image, or some other limited aspect of a digital album, without remaining portions of the digital album file. The invitation may comprise a link that directs the viewer to a digital album file stored on the distribution server node 120, where the entire digital album file may be viewed. Similarly, emailing the digital album as a whole may comprise emailing an invitation to view the digital album, without attaching an entire digital album file.

In response to a user selection to enable zooming, the digital album production modules 211 may be configured to set zoom settings to enable zooming in on the album cover when viewing the album with the digital album viewer modules 231. Some embodiments may not include a selectable/deselectable zooming control within the album cover controls.

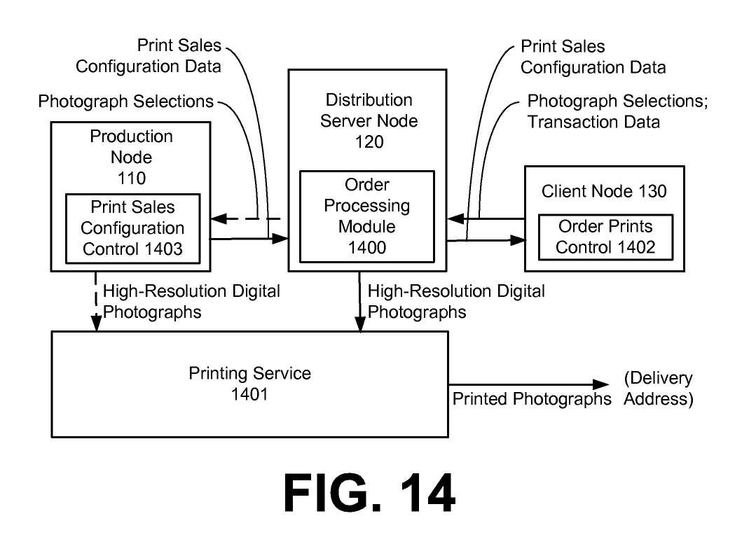

In some embodiments, album cover controls may comprise one or more UI elements configured to set print sales configuration data for a digital album for an album as a whole, e.g., as discussed below in connection with the print sales configuration control 1403 in FIG. 14.

The album spread controls 1102 may comprise design controls, branding controls, and expressions controls, as shown. The design controls may include an update from original control, a selectable/deselectable lock control, border property fields, and background property controls. The branding controls may include a branding preset selection field, selectable/deselectable enable logo on export control, a logo file selection control, and logo position controls. The expressions controls may include a selectable/deselectable enabling expressions control, and/or a selectable/deselectable zooming control.

In response to a user selection of the update from original control, digital album production modules 211 may be configured to replace an imported album page with a corresponding page from an original album file. Album page origination information may be associated with digital album pages within a digital album for use in the replace operation.

In response to a user selection of the lock control, digital album production modules 211 may be configured to toggle between enabling/disabling user repositioning and reorienting, within the album page design work area, of images included in an album spread.

In response to a user selection to enable expressions, digital album production modules 211 may be configured to respond to selection/deselection of a plurality of permission options, applicable when the digital album is viewed with the digital album viewer modules 231. The permission options may include, e.g., permitting guests to share an album page as a whole on social media, permitting guests to save the album page as a whole to a local device, permitting guests to email the album page as a whole, and/or permitting guests to comment on the album page as a whole. In response to a user selection of any of the plurality of permission options, the digital album production modules 211 may be configured to set corresponding permission settings for the album page as a whole. Some embodiments may not include expressions controls within the album spread controls, however may include expressions controls applicable to albums as a whole, as described above with respect to album cover controls, and expressions controls applicable to individual images within an album, as described below with respect to album box controls.

In response to a user selection to enable zooming, the digital album production modules 211 may be configured to set zoom settings to enable zooming on the album page when viewing the album with the digital album viewer modules 231. In some embodiments, zooming on an album page may comprise toggling between a single image view and an album page view, in response to a user input. For example, when viewing an album page with six images, a user may tap/click/select a single one of the images. In response to the user selection, and when zooming is enabled for the album page, the digital album viewer modules 231 may be configured to display only the single selected image, e.g., in full screen mode. In response to a user selection from within the single selected image, the digital album viewer modules 231 may be configured to return to an album page view.

In some embodiments, album spread controls may comprise one or more UI elements configured to set print sales configuration data for album spreads, e.g., as discussed below in connection with the print sales configuration control 1403 in FIG. 14.

The album guest book controls 1103 may comprise design controls, branding controls, and expressions controls, as shown. The design controls may include fonts controls, border property fields for image uploads to an album guest book, border property fields for text entries to an album guest book, and background property controls. The branding controls may include any of the branding controls disclosed herein, or optionally none. The expressions controls may include a selectable/deselectable enabling expressions control, and/or a selectable/deselectable zooming control.

In response to a user selection to enable expressions, digital album production modules 211 may be configured to respond to selection/deselection of a plurality of permission options, applicable when the digital album is viewed with the digital album viewer modules 231. The permission options may include, e.g., permitting guests to share a guest book on social media, permitting guests to save the guest book to a local device, permitting guests to email the guest book, and/or permitting guests to comment on the guest book. In response to a user selection of any of the plurality of permission options, the digital album production modules 211 may be configured to set corresponding permission settings for the guest book. Some embodiments may not include expressions controls within the guest book controls, however may include expressions controls applicable to albums as a whole, as described above with respect to album cover controls, and expressions controls applicable to individual images within an album, as described below with respect to album box controls.

In response to a user selection to enable zooming, the digital album production modules 211 may be configured to set zoom settings to enable zooming in on the guest book when viewing the album with the digital album viewer modules 231.

The album box controls 1104 may comprise design controls, branding controls, and expressions controls, as shown. The design controls may include an update from original control, a change image control, a lock control, and border property controls. The branding controls may include a branding preset selection field, selectable/deselectable enable logo on export control, a logo file selection control, and logo position controls. The expressions controls may include a selectable/deselectable enabling expressions control, and/or a selectable/deselectable zooming control.

In response to a user selection of the update from original control, digital album production modules 211 may be configured to replace an individual image with a corresponding image from an original album file, or from a image library from which the individual image originated. Image origination information may be associated with individual images within a digital album for use in the replace operation. In response to a user selection of the change image control, digital album production modules 211 may be configured to display a UI configured for selection of an image, and in response to a received image selection, to replace an individual image with a selected new image. In response to user selection/deselection of the lock control, digital album production modules 211 may be configured to toggle between enabling/disabling user repositioning and reorienting, within the album page design work area, of an individual image.

In response to a user selection to enable expressions, digital album production modules 211 may be configured to respond to selection/deselection of a plurality of permission options, applicable when the digital album is viewed with the digital album viewer modules 231. The permission options may include, e.g., permitting guests to share an individual image on social media, permitting guests to save the individual image to a local device, permitting guests to email the individual image, and/or permitting guests to comment on the individual image. In response to a user selection of any of the plurality of permission options, the digital album production modules 211 may be configured to set corresponding permission settings for the individual image. In some embodiments, digital album production modules 211 may be configured to share an individual image on social media by exporting the image file to a social media server, so that the image itself is viewable to users of the social media. Similarly, emailing an individual image may comprise emailing an image file, e.g., as an attachment to an email. Thus, embodiments may be configured to share individual images differently than entire albums. An entire album may be shared by sharing an invitation and/or limited album file content, as described above, while an individual image may be shared by sharing an entire image file. Furthermore, in some embodiments, the digital album production modules 211 may be configured to provide a UI configured to receive a photographer selection to require overlay of a photographer's logo on top of any saved, shared, and/or emailed image files.

In response to a user selection to enable zooming, the digital album production modules 211 may be configured to set zoom settings to enable zooming in on the individual image when viewing the album with the digital album viewer modules 231.

In some embodiments, album box controls may comprise one or more UI elements configured to set print sales configuration data for individual images, e.g., as discussed below in connection with the print sales configuration control 1403 in FIG. 14.

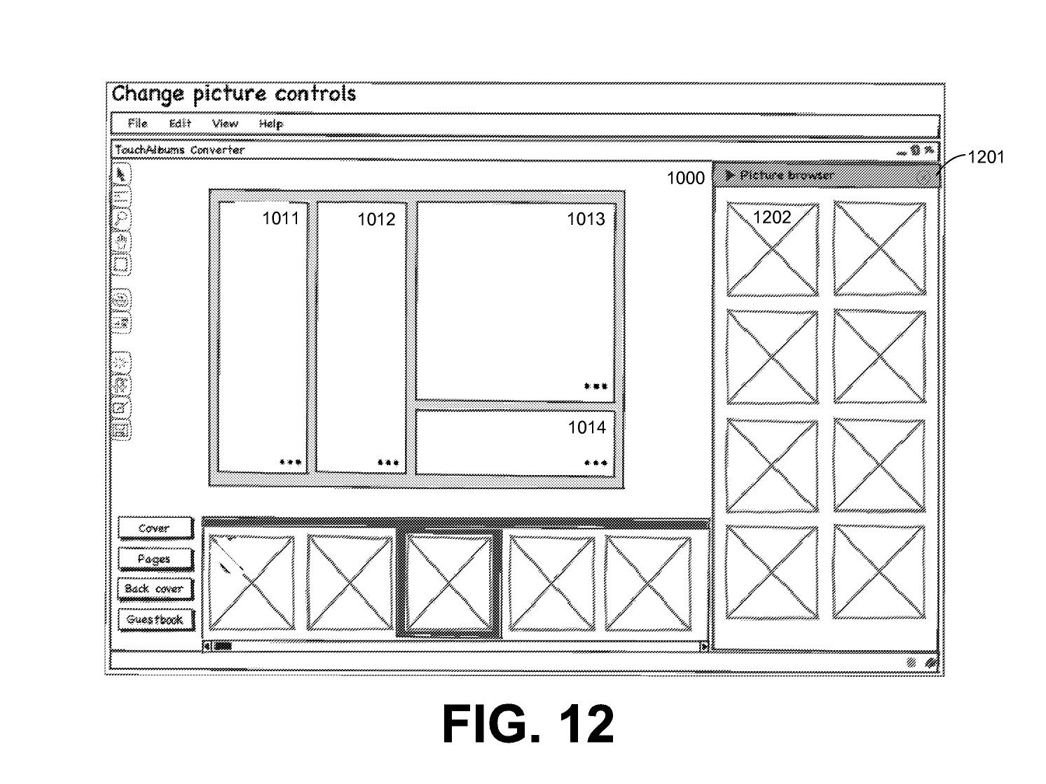

FIG. 12 illustrates an example production node UI in accordance with various embodiments of this disclosure. FIG. 12 includes the main designer window UI of FIG. 10, with a picture browser 1201 shown in the right side column. In some embodiments, digital album production modules 211 may be configured to provide a picture browser 1201 comprising one or more selectable image thumbnails such as 1202. In response to selection of an image thumbnail 1202 in the picture browser 1201, the digital album production modules 211 may be configured to include a corresponding image on an album page in the work area 1000. For example, the image thumbnails 1202 may be dragged and dropped onto the album page in the album page design work area 1000. The images displayed in the picture browser 1201 may be images in an image library that is associated with the digital album. In some embodiments, images that are already included on a digital album page in work area 1000 may be removed from the picture browser 1201, or otherwise marked as used within the picture browser 1201. In some embodiments, all images in an album may be automatically copied into the image library associated with the picture browser 1201.

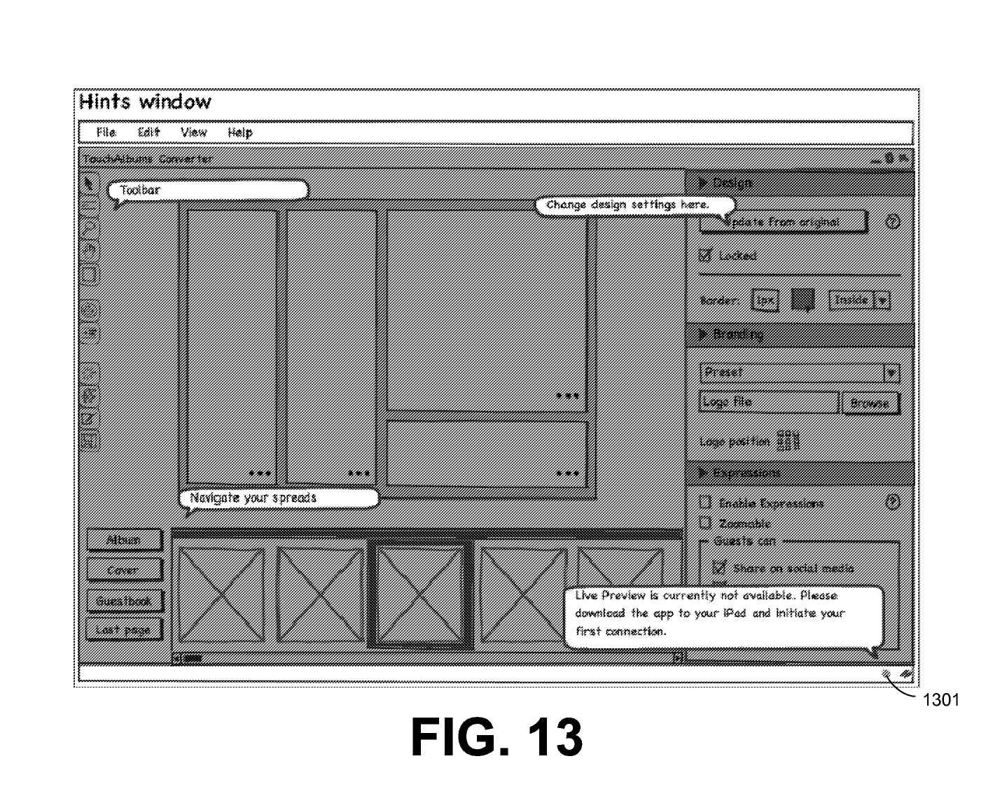

FIG. 13 illustrates an example production node UI in accordance with various embodiments of this disclosure. FIG. 13 includes a hints window UI, comprising the main designer window UI of FIG. 10, with a hints layer comprising instructions for interacting with the various elements of the main designer window UI. In some embodiments, digital album production modules 211 may be configured to display instructions for interacting with one or more aspects of the UI displayed by the digital album distribution modules 221. The instructions provided within the hints layer may be displayed in response to selection of a UI element, such as a mouse over event in the hints window.

FIG. 13 also includes a live preview indicator 1301, which is also shown in FIG. 10 and FIG. 12. In some embodiments, the digital album production modules 211 may be configured to provide a live preview mode, in which a digital album may be created and previewed simultaneously. For example, changes within a digital album that is open within the digital album production modules 211, may be automatically pushed to a client node 130, and viewed with digital album viewer modules 231. When in live preview mode, the live preview indicator 1301 may be illuminated.

FIG. 14 illustrates example aspects of a digital album production and distribution architecture directed to ordering prints, and corresponding methods in accordance with various embodiments of this disclosure. FIG. 14 includes a production node 110, distribution server node 120, client node 130, and printing service 1402. The production node 110 includes a print sales configuration control 1403. The distribution server node 120 includes order processing module 1400. The client node 130 includes an order prints control 1402.

In FIG. 14, the production node 110 may comprise a print sales configuration control 1403 adapted to receive print sales configuration data for a digital album. Print sales configuration data may include, for example, prices for prints of individual images within a digital album, a price for ordering an entire digital album, permissions controlling which images within a digital album may or may not be printed, and crop settings for images within a digital album. A print sales configuration control 1403 may supply one or more UI elements configured to receive the print sales configuration data. The print sales configuration data may be embedded within a digital album, which may be supplied to the distribution server node 120 as shown in FIG. 14, or print sales configuration data may be supplied to the distribution server node 120 separately from the album file itself.

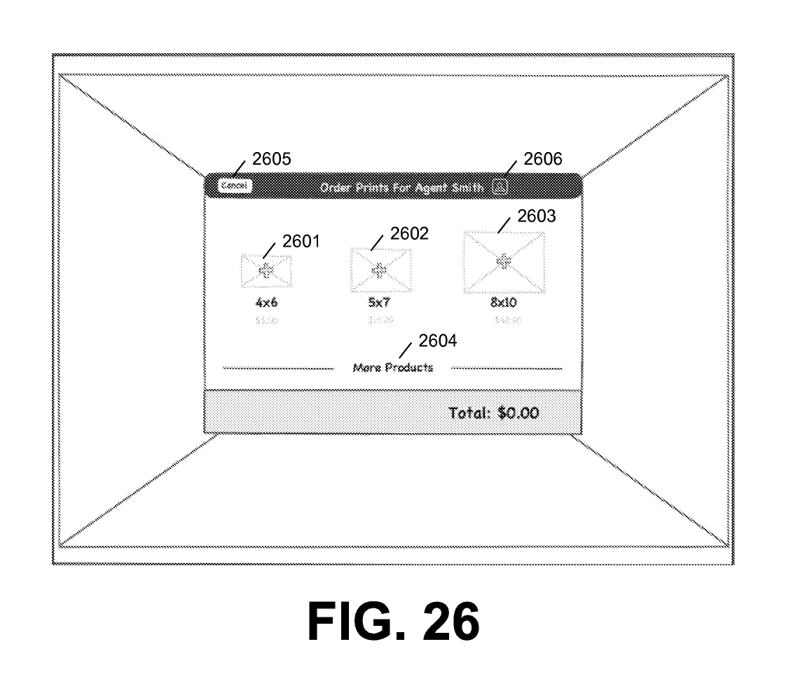

In FIG. 14, a client node 130 equipped with digital album viewer modules 231 (see FIG. 2) may provide an “order prints” control 1402, in addition to the various other aspects of the digital album viewer modules 231 discussed herein. As discussed below in connection with FIG. 26-FIG. 33, the order prints control 1402 may be configured to provide a selection interface at the client node 130 configured to provide print sales configuration data at the client node 130, and to receive order information which may comprise, for example, selections of images within an album, pages within an album, and/or an entire album for printing. The selection interface may also be configured to receive size selections and a desired number of copies of selected images, pages, and/or entire albums, and to calculate a payment amount based on the image selections. The order prints control 1402 may also provide an interface at the client node 130 configured to receive transaction data comprising, inter alia, payment amount, credit card payment information and delivery address(es) for delivery of prints of the selected images, pages, and/or entire albums. The order prints control 1402 may also be configured to initiate sending the image selections and transaction data to the distribution server node 120.

An order processing module 1400 at the distribution server node 120 may be configured to provide print sales configuration data to the client node 130, as well as to receive image selections and transaction data from the client node 130. The order processing module 1400 may provide, for example, a network Application Programming Interface (API) or other interface accessible by the client node 130 and configured to receive image selections and transaction data. In response to receiving the image selections and transaction data from the client node 130, the order processing module 1400 may be configured to process a client payment, to process a photographer payment, and/or to initiate printing and delivery of the received image selections. Processing a client payment may comprise providing the received client credit card payment information and payment amount to a bank server (not shown). Processing a photographer payment may comprise, for example, looking up a photographer corresponding to the image selections, calculating a photographer payment based on the client payment amount, e.g., as a predetermined percentage of the client payment amount, or as a full client payment amount minus applicable service fees, and entering a photographer payment amount in a billing/accounting software system. The billing/accounting software may then credit a photographer account, which may for example result in sending a check to a photographer or making an electronic transfer to a photographer bank account.

In some example embodiments, the order processing module 1400 at the distribution server node 120 may be configured to initiate printing and delivery of the received image selections according to either or both of two methods. In one method, the order processing module 1400 may be configured to order prints directly from a printing service 1401. This method may comprise, inter alia, sending, by the distribution server node 120, high resolution images to the printing service 1401. In another method, the order processing module 1400 may be configured to send the image selections to the production node 110, allowing the photographer to order prints from a printing service such as 1401, or another printing service of the photographer's choosing. The photographer's order may include high resolution images corresponding to the image selections. In some embodiments, the distribution server node 120 may be configured to provide a UI allowing photographer selection from among the available methods of initiating printing. Also, it will be appreciated that the above methods performed by an order processing module 1400 may be fully automated or may include some degree of human administration in some embodiments.

In embodiments in which the order processing module 1400 is configured to order prints directly from a printing service 1401, the distribution server node 120 may comprise a database of high-resolution digital images corresponding to the low-resolution digital images in digital albums distributed by the distribution server node 120. The terms “high resolution” and “low resolution” as used herein are relative terms, so that a high resolution digital image is any digital image with higher resolution than a corresponding low-resolution digital image.

The database of high-resolution digital images may comprise high-resolution digital images and a unique high-res identifier for each high-resolution digital image. The unique high-res identifiers may also be assigned to corresponding low-resolution digital images in a digital album. The order prints control 1402 may be configured to use the assigned high-res identifiers to designate image selections, and the order processing module 1400 may be configured to retrieve identified high-resolution images from the database in response to receiving image selections from the client node 130. The order processing module 1400 may be configured to subsequently send retrieved high-resolution images to the printing service 1401 for printing. In the case where an album page or entire album is ordered, the order processing module 1400 may send page and/or album layout data along with the retrieved high-resolution images. The order processing module 1400 may also be configured to send printing service transaction information to the printing service 1401. Printing service transaction information may comprise, inter alia, the delivery address(es) for delivery of prints, and printing service payment information. The printing service 1401 may then produce the requested prints and send printed images to the delivery address(es). The delivery address(es) may include an address of the person placing the order (the purchaser) and/or the photographer. In some embodiments, the distribution server node 120 may be configured to provide a UI configured to receive a photographer selection regarding delivery of prints, to allow a photographer to choose to always or sometimes receive the prints. Such embodiments permit a photographer to optionally inspect ordered prints or package them before sending them to the purchaser.

In some embodiments, unique high-res identifier for each high-resolution image may be assigned at the production node 110 during album production. The production node 110 may be configured to assign a unique high-res identifier to each low-resolution image in a digital album, and to also assign the high-res identifier to a corresponding high-resolution image. A UI for user-assisted assignment of high-res identifiers may be provided in some embodiments. The production node 110 may be configured to send high-resolution image with corresponding unique high-res identifiers to the distribution node 120 along with a corresponding digital album.

In embodiments in which the photographer selects to transact with the printing service 1401 directly, then the production node 110 need not provide the high-resolution images to the distribution node 120. However, it is still advantageous to have the unique high-res identifiers in the digital album for the purpose of image selection and subsequent identification of high-resolution image for print ordering.

FIG. 15-FIG. 35 illustrate example client node UI in accordance with various embodiments of this disclosure. In general, the client node UI may be configured to retrieve digital album files from a distribution server node, and view and interact with digital album files, including any of the properties thereof.

Some example client node devices may be configured to view touch-interactive digital albums. The touch-interactive properties of a digital album may be included in a digital album file, or may be applied at the client node device. Touch interaction may be applied using one or more “meta-files” describing locations of touch-interactive areas and identifying actions to take in response to selection (a touch or gesture) of a touch-interactive area.

Some example client node devices may include a processor, a memory, a touch-screen display, and digital album viewer modules 231. As discussed in further detail below, the digital album viewer modules 231 may be configured to display a touch-interactive digital album on the touch-screen display. The touch-interactive digital album may be displayed for example in response to a touch selection of the digital album on the touch-screen display. In some embodiments, the touch selection may be received via a touch interactive album library comprising one or more touch-interactive digital albums available to a user of the digital album client node device. In some embodiments, digital album viewer modules 231 may be configured to provide a touch-interactive album finder that is configured to receive album identification information and send the album identification information to a distribution server node, and the displayed touch-interactive digital album may be an album returned by the distribution server node.

In some embodiments, digital album viewer modules 231 may be configured to display album spreads within the digital album on the touch-screen display in response to touch spread navigation inputs on the touch-screen display. The digital album viewer modules 231 may also be configured to display a page flip sequence in response to a touch spread navigation input. Each displayed album spread may comprise one or more digital images at custom defined positions within the album spread. In some embodiments, digital album viewer modules 231 may be configured to detect a client node device type, and to default to either a spread-by-spread view of the digital album or an image-by-image view of the digital album in response to the detected client node device type.

In some embodiments, digital album viewer modules 231 may be configured to individually display a selected image from an album spread on the touch-screen display in response to a touch image selection input on the touch-screen display. The touch-interactive controls may be displayed with the selected image, and the touch-interactive controls may comprise, for example, one or more of an order prints control, a share image control, an email image control, and a save image control. The displayed touch-interactive controls may be those that are allowed for the selected image in album properties associated with the digital album. The touch-interactive controls may be displayed for example in response to a context-view input on the selected image on the touch-screen display.

In some embodiments, digital album viewer modules 231 may be configured to display on the touch-screen display a touch interactive order prints User Interface (UI), a touch interactive share image UI, a touch interactive email image UI, or a touch interactive save image UI, configured to order prints of the selected image, share the selected image via a social media website, email the selected image, and save the selected image to the memory, respectively, in response to a touch selection of the order prints control, share image control, email image control, or save image control.

The digital album viewer modules 231 may also be configured to display a touch-interactive guestbook access control with the digital album, and to display a touch interactive guestbook UI in response to a touch selection of the guestbook control.

The digital album viewer modules 231 may also be configured to display touch-interactive controls with the digital album comprising one or more of an order album control, a share album control, an email album control, and a save album control, and display touch interactive order album UI, a touch interactive share album UI, a touch interactive email album UI, or a touch interactive save album UI, configured to order a printed digital album as a whole, share an invitation to view the digital album via a social media website, email an invitation to view the digital album, and save the digital album to the memory, respectively, in response to a touch selection of the order album control, share album control, email album control, or save album control.

In conjunction with, or in addition to the above described aspects relating to touch-interactive digital albums, some example client node devices may include a processor, a memory, a display, and digital album viewer modules 231 comprising, inter alia, an album finder, distribution server node communication modules, an album library view handler, a spread context-view handler, a single-image view handler, an account manager, an order manager, and a display manager, along with any number of other components implementing corresponding features disclosed herein.

An album finder may be configured to receive album identification information, wherein the digital album viewer modules are configured to send the album identification information to a distribution server node, for example in connection with FIG. 15-FIG. 18.

Distribution server node communication modules may be configured to send and receive album identification data, digital album files, album interaction data, and order information between the client node device and a pre-designated distribution server node, as disclosed in connection with FIG. 15-FIG. 35. In some embodiments, the distribution server node communication modules may be configured to only communicate with an identified distribution server node. The client node may be required to access digital album files via only the identified distribution server node.

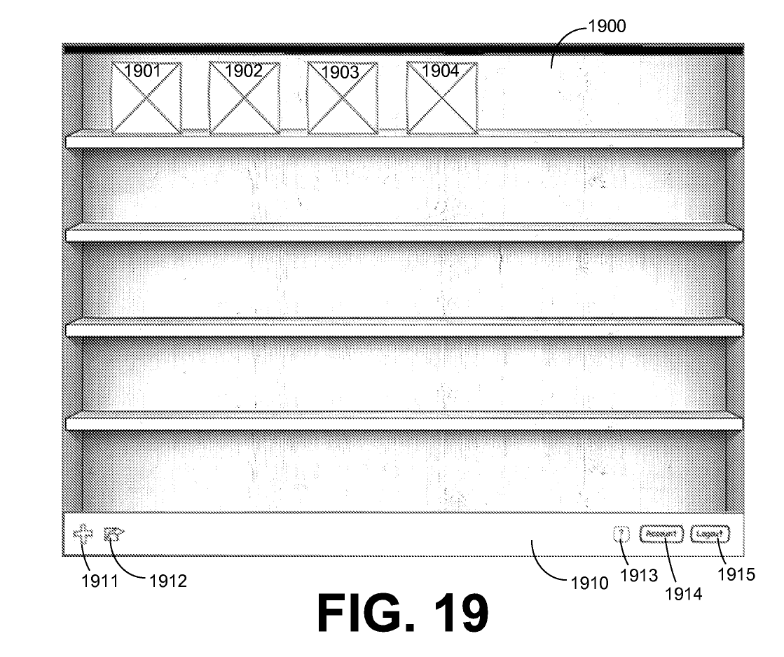

An album library view handler may be configured to display an album library UI such as FIG. 19, on the client node device display. The album library UI may comprise selectable cover images of digital album files, the digital album files each comprising an album cover image and one or more album spreads, each album spread comprising one or more images, and each image having a defined position within an album spread, as disclosed herein. The album library UI may also comprise an album sharing control configured to receive recipient identifications of one or more sharing recipients an entire digital album file as illustrated in connection with FIG. 19. The digital album viewer modules may be configured to check interaction permission settings in digital album files, and to enable and disable the album sharing control according to an interaction permission setting.

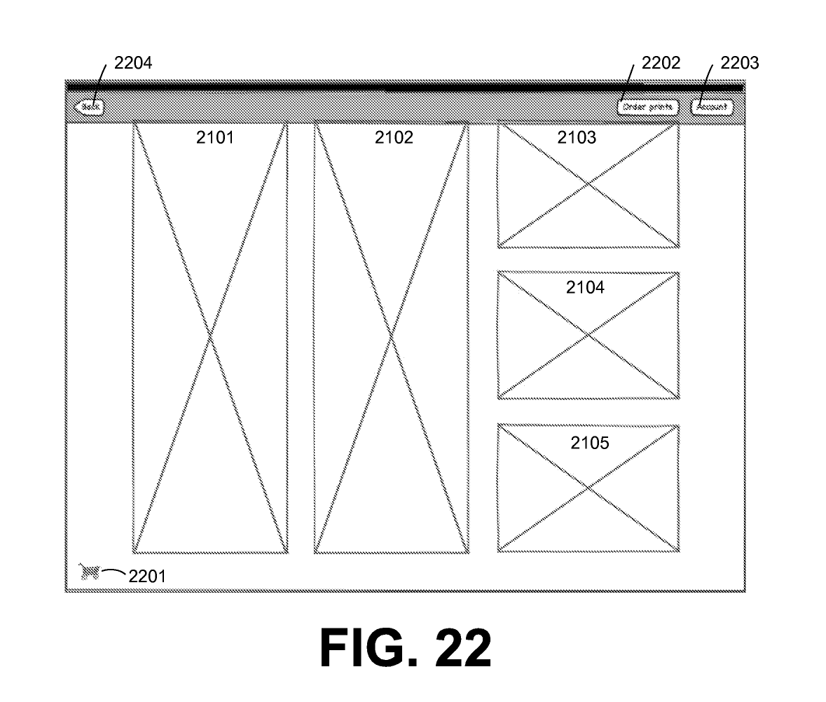

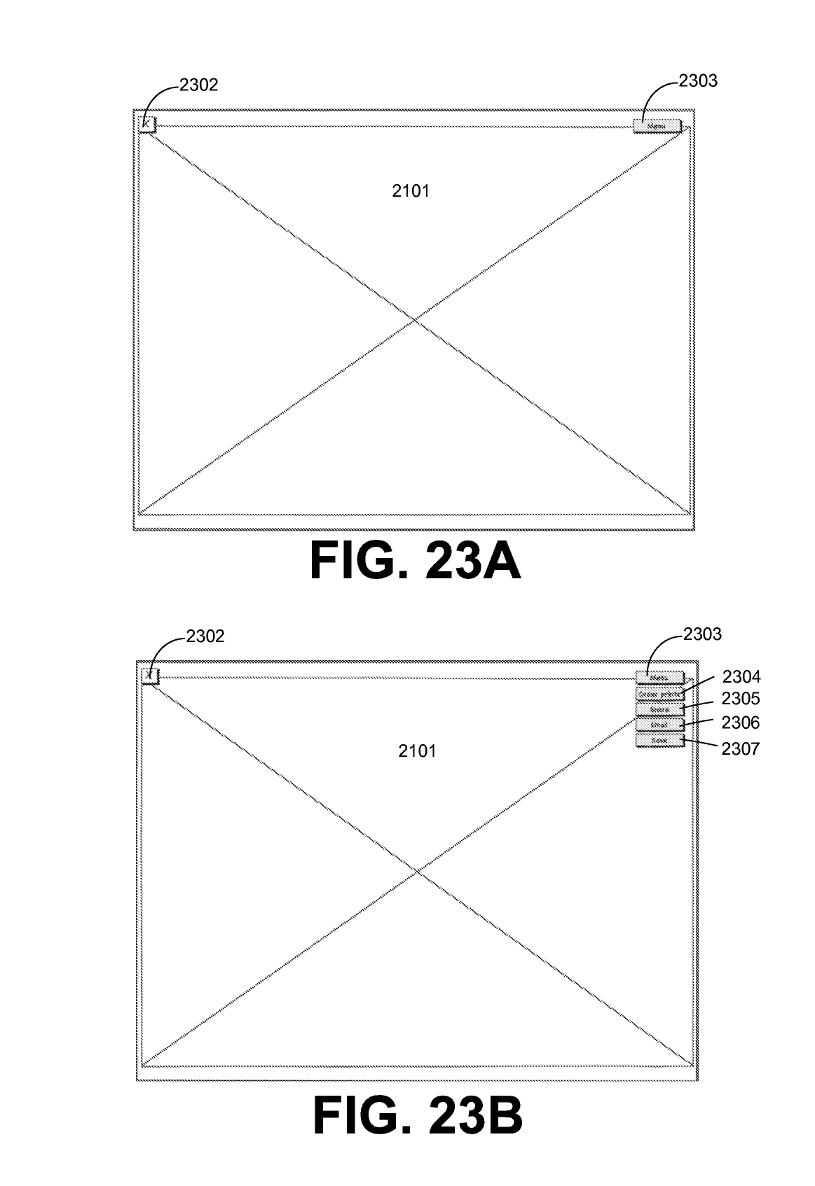

A spread context-view handler may be configured to display a spread context-view UI such as FIG. 22 on the client node device display. The spread context-view UI may comprise an album spread from a selected digital album file, including one or more images at their defined positions within the album spread. The spread context-view handler may be further configured to display an order spread prints control, and to respond to selection of the order spread prints control by providing an order prints UI such as any of FIG. 26-FIG. 28. The order prints UI may be configured to receive orders of the images displayed in an album spread, as well as optionally any images within a digital album, a digital album as a whole, and/or one or more album spreads within a digital album, including all of the images in their defined positions on an album spread. The spread context-view handler may be further configured to receive a selection of any of the one or more images within a displayed album spread and to respond to selection of a image within a displayed album spread by providing a single-image UI, such as FIG. 23A or FIG. 23B, comprising a selected image.

A single-image view handler may be configured to display a single-image UI such as FIG. 23A or FIG. 23B on the client node device display, the single-image UI comprising a single image from a selected digital album file, and further configured to display single-image interaction controls comprising an order image prints control, an image sharing control, an email image control, and a save image control, as shown in FIG. 23B. The single-image view handler may be configured to check interaction permission settings in digital album files, and to enable and disable one or more of the interaction controls in the single-image UI according to the interaction permission settings.

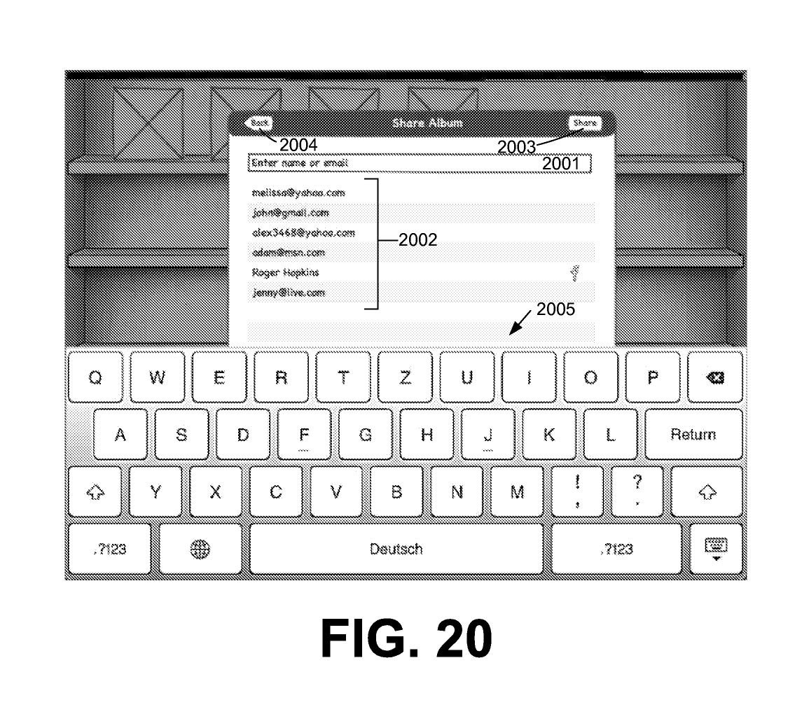

The single-image view handler may be configured to respond to a selection of the order image prints control by displaying an order prints UI such as any of FIG. 26-FIG. 28, wherein the provided order prints UI is configured to receive print orders of a displayed single image. The single-image view handler may be configured to respond to a selection of the image sharing control by displaying image sharing UI, similar to FIG. 20, that is configured to receive recipient identifications of one or more sharing recipients a displayed single image. The single-image view handler may be configured to respond to a selection of the save image control by displaying a UI configured to save a displayed single image in the client node device memory.

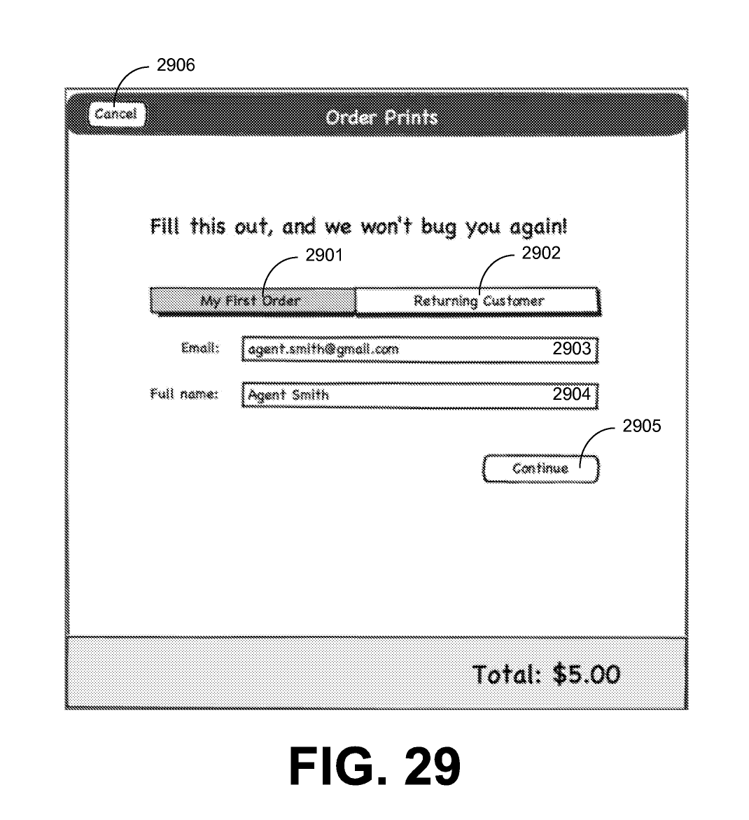

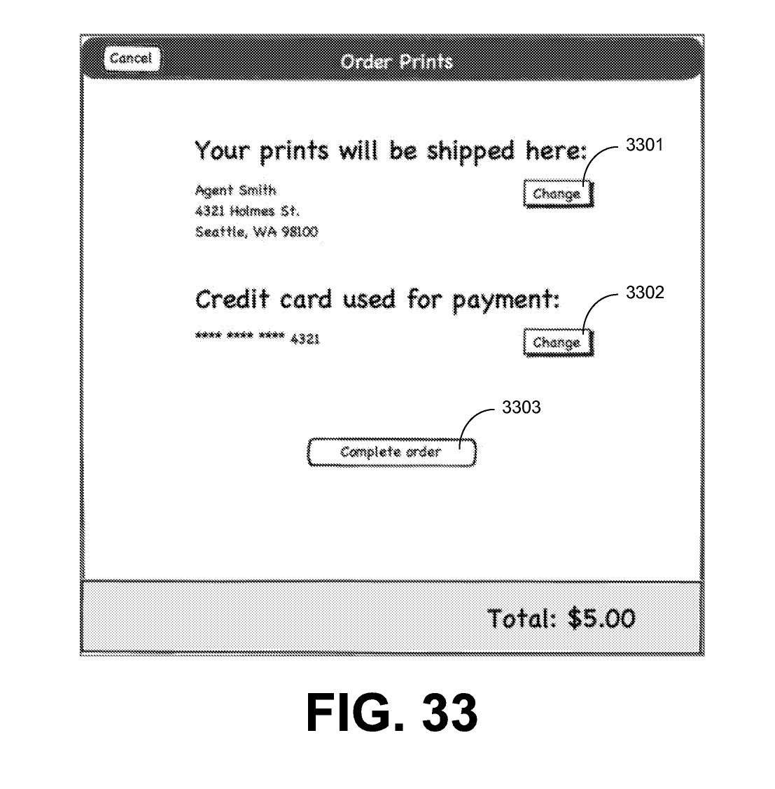

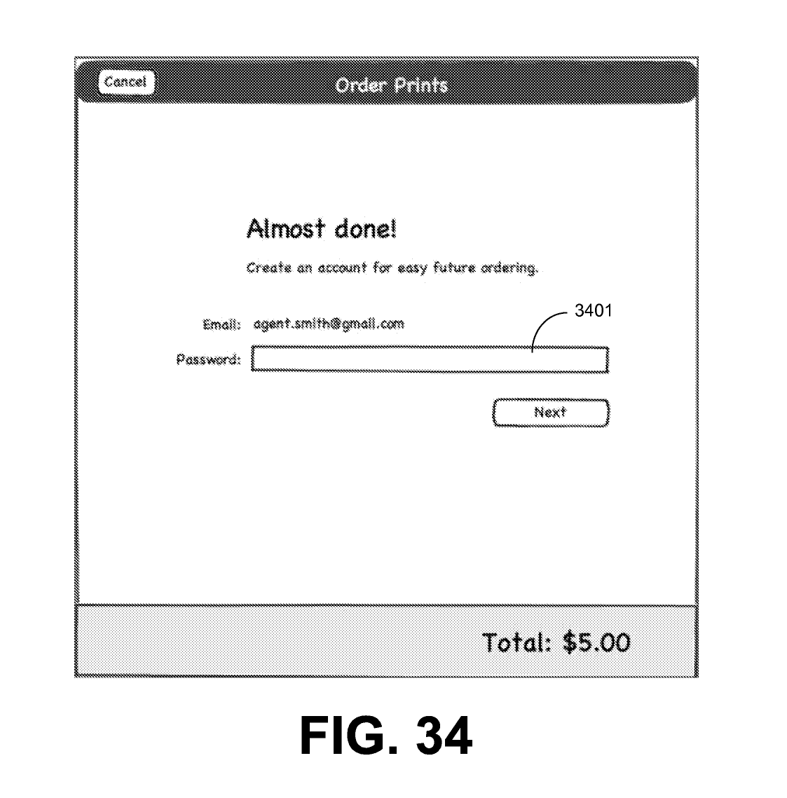

An account manager may be configured to receive, store, and subsequently modify user profile data and/or other data. For example, user profile data may be collected via FIG. 29-FIG. 31 and/or FIG. 33 and FIG. 34. Other data may include order history and digital album files in a digital album library.

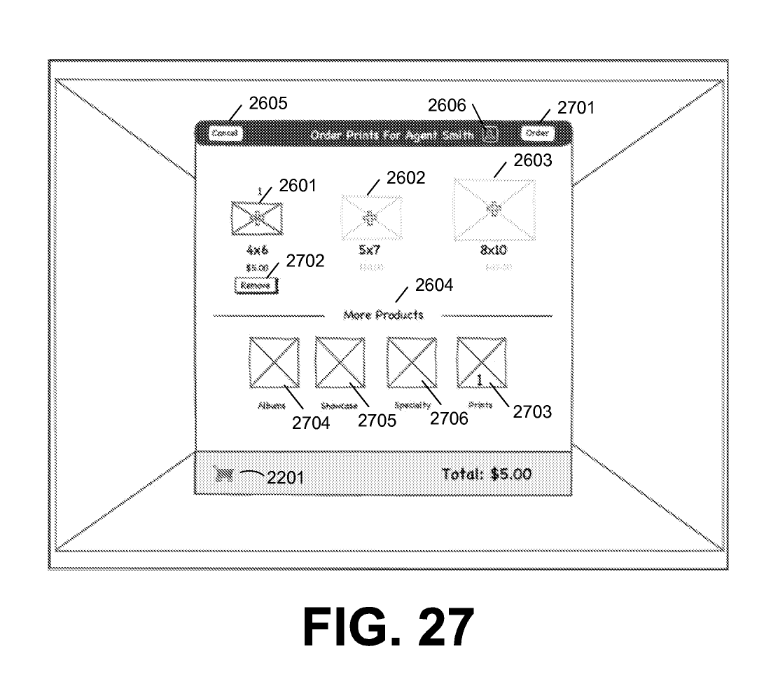

An order manager may be configured to receive, store, and subsequently modify order information collected for example via FIG. 29-FIG. 31 and/or FIG. 33. An order manager may also interact with order prints UI such as any of FIG. 26-FIG. 28, and may manage shopping cart data and order total information provided in connection with FIG. 26-FIG. 35. As illustrated in FIG. 26-FIG. 28, the various order prints UI may include a plurality of differently sized print order controls, each print order control comprising a selectable thumbnail of an image or spread that is orderable using the print order control, and wherein a size of a print order control corresponds to a size of an image or spread to be ordered using the print order control. Also, one or more of the order prints UI may include an album order control configured to place an order for an entire digital album, as illustrated in FIG. 27.

A display manager may be configured to detect a client node device type, and to set view setting to either a spread-by-spread view setting or an image-by-image view setting, based on a detected device type. For example, on a large screen device such as a tablet-style device, the display manager may set a view setting to a spread-by-spread view setting. On a small screen device such as a mobile phone-style device, the display manager may set a view setting to an image-by-image view setting. In some embodiments, a display manager may be configured to set a view setting to a reduced spread view, comprising, for example, a spread-by-spread view wherein displayed “spreads” contain limited numbers of images. For example, in some embodiments a reduced spread view may display a maximum of 4 images per “spread” on some device types, while on some device types, a full spread-by-spread view may display full spreads, and optionally on some device types, an image-by-image view may display single images at a time.

Turning now to FIG. 15-FIG. 35 in detail, FIG. 15 illustrates an example client node UI in accordance with various embodiments of this disclosure. The example client node UI may be touch-interactive in some embodiments. FIG. 15 provides a start-up UI that may be provided by digital album viewer modules 231 in response to a new user opening an album viewing application for a first time. FIG. 15 includes a “find and album” control 1501 and a “what's this app for?” control 1502.

In some embodiments, the digital album viewer modules 231 may be configured to respond to selection of the “find and album” control 1501 by displaying a first album/account access UI such as illustrated in FIG. 16. The digital album viewer modules 231 may be configured to respond to selection of the “what's this app for?” control 1502 by providing a description of the album viewing application comprising the album viewer modules 231.

In some embodiments, digital album viewer modules 231 may be configured to display the start-up UI of FIG. 15 when a client node 130 does not have any previously stored digital albums and/or previously stored album viewing account login information. Once the digital album viewer modules 231 have stored one or more albums at the client node 130, and/or stored album viewing account login information at the client node 130, the digital album viewer modules 231 may be automatically reconfigured to display an album library UI (FIG. 19) in response to a user opening the album viewing application. The digital album viewer modules 231 may also be automatically reconfigured to automatically connect and log into a distribution server node 120 using album viewing account login information stored at the client node 130, in response to a user opening the album viewing application.

FIG. 16 illustrates an example client node UI in accordance with various embodiments of this disclosure. The example client node UI may be touch-interactive in some embodiments. FIG. 16 provides a first album/account access UI that may be provided by digital album viewer modules 231 in response user selection of the “find and album” control 1501 in FIG. 15. FIG. 16 is divided into alternative album and account access tools. The left side of FIG. 16 includes an album access tool, including a first set album access controls configured to find an album by name. The first set of album access controls may include a category selection control 1601, a studio identification field 1602, and a submit (go) control 1603. The right side of FIG. 16 includes an account access tool comprising an account login control 1604. The account login control 1604 may be configured to leverage user account login information from a third-party web service, such as user account login information from a FACEBOOK®, GOOGLE®, or other web service account.

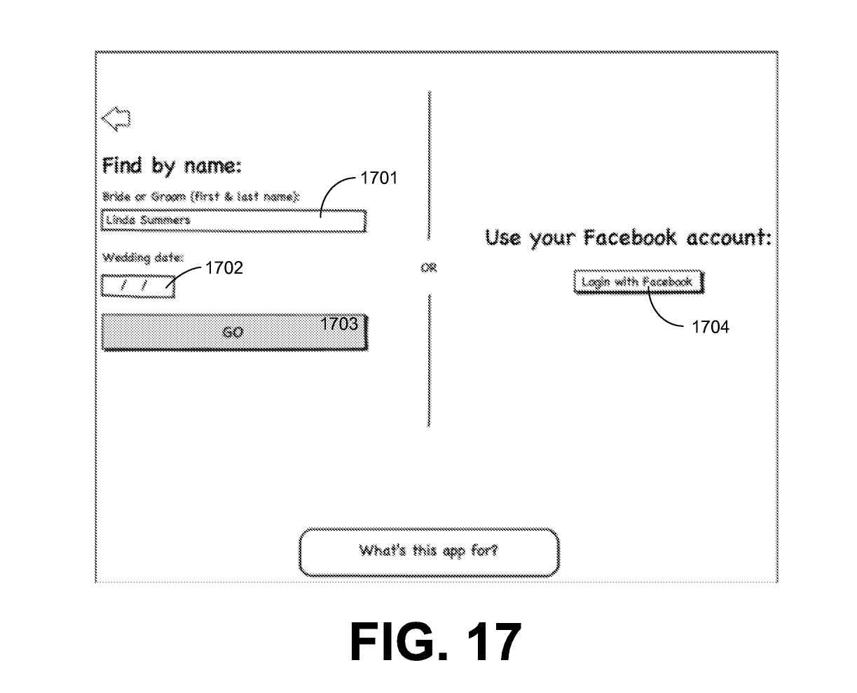

In some embodiments, the digital album viewer modules 231 may be configured to receive album identification information via the first and/or second album/account access UI provided in FIG. 16 and FIG. 17. For example, the digital album viewer modules 231 may be configured to respond to selection of the category selection control 1601 in FIG. 16 by displaying a list of selectable event categories such as, wedding or engagement, graduation, bridal shower, baby shower, etc. A received selection may be displayed in the category selection control 1601. Digital album viewer modules 231 may be configured to receive a photography studio name via the studio identification field 1602. In some embodiments, the digital album viewer modules 231 may be configured to respond to selection of the submit control 1603 by storing the received photography studio name and received category selection at the client node 130 and displaying a second album/account access UI (FIG. 17) at the client node 130. In some embodiments, the digital album viewer modules 231 may be configured to respond to selection of the submit control 1603 by sending the received photography studio name and received category selection to the distribution server node 120.

In embodiments configured to send the received photography studio name and received category selection to the distribution server node 120, the distribution server node 120 may be configured to return a list of selectable albums matching the received photography studio name and category selection. The digital album viewer modules 231 may be configured to display the list of selectable albums, receive an album selection, optionally request an alum password (discussed further below), send album selection and password information to the distribution server node 120, and receive a digital album file returned from the distribution server node 120.

In some embodiments, the digital album viewer modules 231 may be configured to respond to selection of the account login control 1604 by providing a login UI with username (e.g. email address) identification field and a password identification field, similar to FIG. 34. Received username and password information may be sent to the distribution server node 120, or to a third-party web service for verification. In some embodiments, the digital album viewer modules 231 may be configured to display the album library UI (FIG. 19) in response to verification of the username and password information from the distribution server node 120 or third-party web service.

FIG. 17 illustrates an example client node UI in accordance with various embodiments of this disclosure. The example client node UI may be touch-interactive in some embodiments. FIG. 17 provides a second album/account access UI that may be provided by digital album viewer modules 231 in response to a user selection of the submit control 1603 in FIG. 16. FIG. 17 is divided into alternative album and account access tools. The left side of FIG. 17 includes an album access tool, including a second set album access controls configured to find an album by name. The second set of album access controls may include an album owner identification field 1701, an album date field 1702, and a submit control such as the “go” control 1703. The right side of FIG. 17 includes an account access tool comprising an account login control 1704 which may be configured as described above in connection with FIG. 16.

FIG. 17 provides further example elements by which the digital album viewer modules 231 may be configured to receive album identification information In some embodiments, the digital album viewer modules 231 may be configured to receive an album owner name via the album owner identification field 1701. The album owner name may identify, for example, the person(s) for whom the album was created by the professional photographer. For example, the album owner may be the bride and/or groom at a wedding. In some embodiments, the digital album viewer modules 231 may be configured receive an album date via the album date field 1702. The album date may be the date of an event corresponding to the album, e.g., a wedding date. In some embodiments, the digital album viewer modules 231 may be configured to identify the album owner identification field and/or album date field according to a selection received via the category selection control in FIG. 16. For example, when a wedding is selected from FIG. 16, the album owner identification field in FIG. 17 may be identified as Bride and/or Groom name, as shown, and the album date field may be identified as wedding date, as shown.

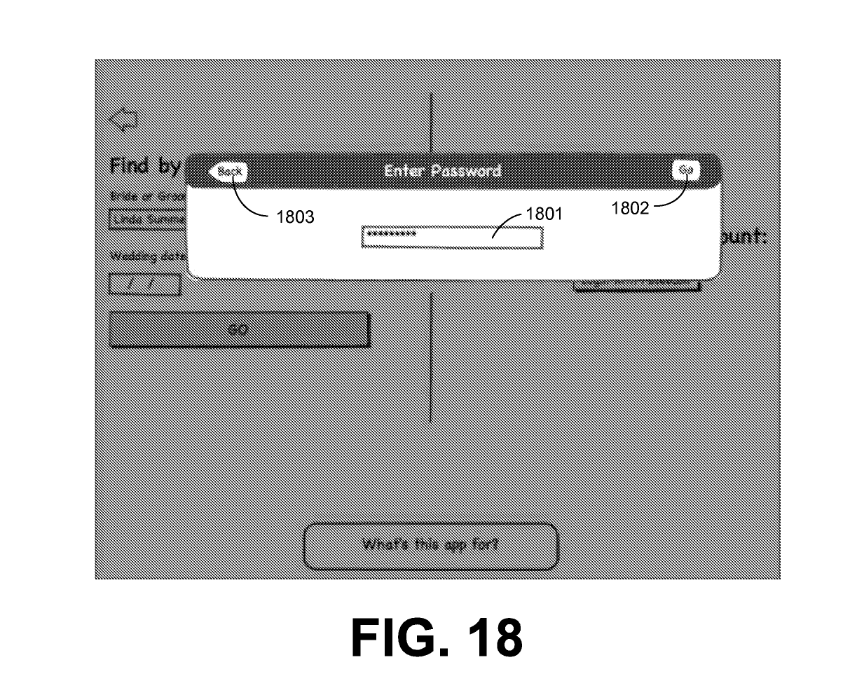

In some embodiments, the digital album viewer modules 231 may be configured to respond to selection of the submit control 1703 in FIG. 17 by storing the received album owner name and/or album date at the client node 130 and displaying an album password UI (FIG. 18) at the client node 130. In some embodiments, the digital album viewer modules 231 may be configured to respond to selection of the submit control 1703 by sending the received album owner name and/or album date to the distribution server node 120.

In embodiments configured to send the received album owner name and/or album date to the distribution server node 120, the distribution server node 120 may be configured to identify a digital album matching the received album owner name and/or album date. If a password is required to access the identified album, the distribution server node 120 may return a password request. If no password is required to access the identified album, the distribution server node 120 may return the identified album. The digital album viewer modules 231 may be configured to display a password request (FIG. 18) and/or display the digital album identified and returned by the distribution server node 120, and to place the received album in the album library accessible via an album library UI (FIG. 19).

FIG. 18 illustrates an example client node UI in accordance with various embodiments of this disclosure. The example client node UI may be touch-interactive in some embodiments. FIG. 18 provides an album password UI that may be provided by digital album viewer modules 231 in response to a user selection of the submit control in FIG. 17. FIG. 18 includes an album password identification field 1801, a submit control 1802 such as the “go” control, and a “back” control 1803 for returning to FIG. 17.

In some embodiments, the digital album viewer modules 231 may be configured to receive a password via the album password identification field 1801. The digital album viewer modules 231 may be configured to respond to selection of the submit control 1802 in FIG. 18 by storing the received password at the client node 130 and/or sending the received password, optionally along with other album identification information received, e.g., via FIG. 16 and/or FIG. 17, to the distribution server node 120. The distribution server node 120 may be configured to retrieve an album identified by received album identification information, verify the password, and return the identified album to the client node 130. The digital album viewer modules 231 may be configured to display the album upon receiving it from the distribution server node 120, and/or place the received album in the album library accessible via an album library UI (FIG. 19). In some embodiments, the digital album viewer modules 231 may be configured to respond to selection of the “back” control 1803 by returning to an album/account access UI such as FIG. 16 and/or FIG. 17.

In some embodiments, the digital album viewer modules 231 may be configured to provide the album password UI only when a password is required for album access. For example, the digital album viewer modules 231 may be configured to check with the distribution server node 120 to determine if a password is required to access an album identified via FIG. 16 and/or FIG. 17. The digital album viewer modules 231 may be configured to provide the album password UI in response to an indication that a password is required from the distribution server node 120. In some embodiments, the album password UI may be provided regardless of whether a password is required to access an album identified via FIG. 16 and/or FIG. 17.

FIG. 19 illustrates an example client node UI in accordance with various embodiments of this disclosure. The example client node UI may be touch-interactive in some embodiments. FIG. 19 provides an album library UI that may be provided by digital album viewer modules 231 in response to a user account login, e.g., from an account login control shown in FIG. 16 and FIG. 17. FIG. 19 includes an album library area 1900 and a control bar 1910. The album library area 1900 comprises one or more selectable album thumbnails 1901, 1902, 1903, 1904, represented in FIG. 19 as the boxes with crossing diagonals on the top shelf. A control bar 1910 across the bottom of FIG. 19 includes an add new album control 1911 (represented by the plus icon), an action control 1912 (represented by the arrow icon), a help control 1913(represented by the question mark icon), an account control 1914, and a logout control 1915.

In some embodiments, the digital album viewer modules 231 may be configured to store any albums downloaded to the client node 130 in an album library, and to display, in the album library UI, selectable album thumbnails 1901-1904 for each album in the album library. The selectable album thumbnails 1901-1904 may comprise album cover images. The digital album viewer modules 231 may be configured to display a single album file, in response to receiving an album thumbnail selection such as one of 1901-1904. For example, a selected album cover may be displayed in response to a selection such as a single-tap of one of selectable album thumbnails 1901-1904 in FIG. 19. From an album cover display, subsequent spreads within an album may be viewed for example by turning album pages as described herein.

In some embodiments, the digital album viewer modules 231 may be configured to respond to a selection of the add new album control 1911 (represented by the plus icon) by presenting an album access UI comprising, for example, elements of FIG. 16, FIG. 17, and/or FIG. 18. The digital album viewer modules 231 may be configured to respond to a selection of a help control 1913 (represented by the question mark icon) by displaying instructions for using a digital album viewer application comprising the album viewer modules 231.

The digital album viewer modules 231 may be configured to respond to a selection of an action control 1912 (represented by the arrow icon) by displaying an album sharing UI such as FIG. 20, allowing sharing of a selected album from FIG. 19, where the album was selected for example by alternate selection mode described above. The digital album viewer modules 231 may be configured to enable and disable the action control 1912 in FIG. 19 based on album sharing permissions for each digital album. Sharing permissions may be set for a digital album file during album production, and the digital album viewer modules 231 may be configured to read an album sharing permission attribute for each digital album in the album library, and to enable/disable album sharing controls, such as the illustrated action control 1912, based on the state of the album sharing permission attribute.

In some embodiments, the digital album viewer modules 231 may be configured to respond to a selection of an account control 1914 by displaying an account management UI. The account management UI may be configured to retrieve, display, and/or modify account information stored at the distribution server node 120 and/or in a client node 130 memory. Account information may include, e.g., account name, account password, account billing/shipping address, and pending and/or completed orders associated with the account.

In some embodiments, the digital album viewer modules 231 may be configured to respond to a selection of a logout control 1915 by sending a logout instruction to the distribution server node 120. In some embodiments, the digital album viewer modules 231 may be configured to respond to a selection of a logout control 1915 by logging out from one or more album viewer modules 231 at the client node 130, requiring subsequent login for further access to the album library UI, digital albums in the album library and user account information.

FIG. 20 illustrates an example client node UI in accordance with various embodiments of this disclosure. The example client node UI may be touch-interactive in some embodiments. FIG. 20 provides an album sharing UI that may be provided by digital album viewer modules 231 in response to a user selection of an action control illustrated in FIG. 19. FIG. 19 includes a recipient identification field 2001, a list of recipients 2002, a “share” control 2003, and a “back” control 2004. The soft typewriter 2005 illustrated at the bottom of FIG. 19 is an example standard touch-interactive typewriter that may be presented whenever a user is entering text into a field such as 2001, or any of the various other touch interactive fields disclosed herein which are configured to receive text inputs.

In some embodiments, the digital album viewer modules 231 may be configured to receive one or more recipient identifications via the recipient identification field 2001. A recipient may be identified for example via recipient email address, or by other identifier such as recipient name, telephone number, or FACEBOOK® name. The digital album viewer modules 231 may suggest auto-complete options by comparing information entered in the recipient identification field with information in an address/contacts list stored at the client node 130, or with contacts associated with a FACEBOOK®, GOOGLE®, or other third party web service account for which the digital album viewer modules 231 have account access information.

In some embodiments, the digital album viewer modules 231 may be configured to place completed recipient identifications in the list of recipients 2002 underneath/adjacent the recipient identification field 2001, in response to a user indication that a recipient identification in the recipient identification field 2001 is complete, e.g., in response to a user selection of the “return” key in a keyboard 2005, or in response to a user selection of an auto-complete suggestion.

In some embodiments, the digital album viewer modules 231 may be configured to respond to selection of the “share” control 2003 by sending an album identification and list of recipients to the distribution server node 120. The distribution server node 120 may be configured to check sharing permissions for the identified album, and if allowed, to share the identified album by sending the digital album file and/or a digital album file identifier to the recipients identified in the recipient identification field 2001. The digital album viewer modules 231 may be configured to respond to selection of the “back” control 2004 by returning to the album library UI of FIG. 19.

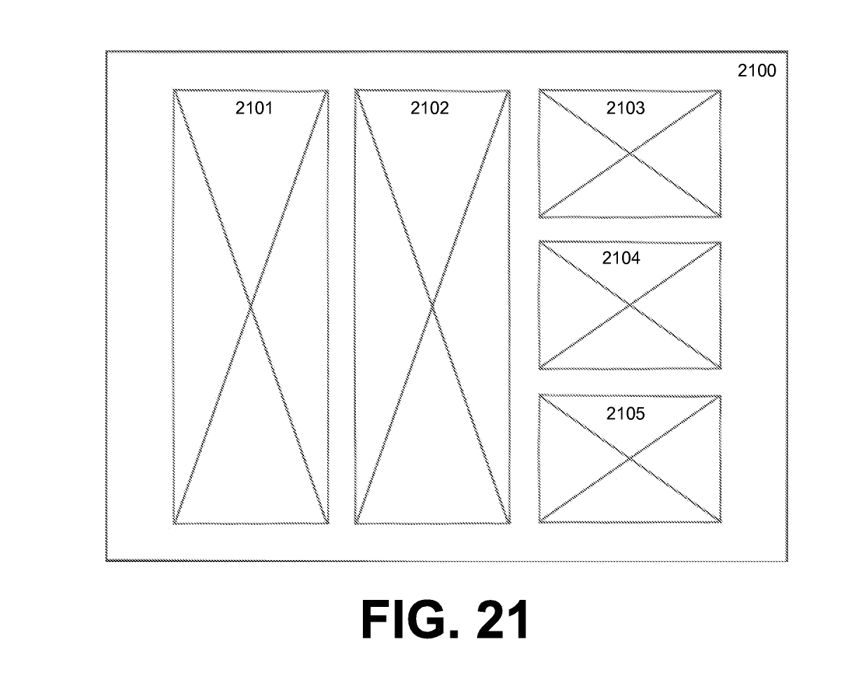

FIG. 21 illustrates an example client node UI in accordance with various embodiments of this disclosure. The example client node UI may be touch-interactive in some embodiments. FIG. 21 provides an album spread UI that may be provided by digital album viewer modules 231 in response to a user navigating among the spreads of an album initially selected from FIG. 19, FIG. 16, and/or FIG. 17. FIG. 21 includes one or more selectable images 2101, 2102, 2103, 2104, 2105, arranged on an album spread page 2100, wherein the image arrangement on the spread 2100 is pre-selected by the photographer using, e.g., a production node 110 as described above. The images 2101-2105 are represented in FIG. 21 as boxes with crossing diagonals. Positions of each of the images 2101-2105 may be defined as touch-interactive areas as described in connection with the production node, and the digital album viewer modules 231 may be configured to respond to touch selections of a selected one of the images 2101-2105 by taking actions described herein.

In some embodiments, the digital album viewer modules 231 may be configured to respond to a context view selection by displaying an album spread context-view UI such as FIG. 22. In some embodiments, a context view selection may comprise a tap on a corner or other designated touch-interactive area of an album spread UI, or a tap on a control provided within an album spread UI, or for example a single- or double-tap on a touch screen, anywhere within an album spread UI.

In some embodiments, the digital album viewer modules 231 may be configured to respond to an image selection of, e.g., selected image 2101, by displaying a single-image UI such as FIG. 23A, comprising the selected image 2101. An image selection may comprise, e.g., a single- or double-tap on a selected image 2101 within the album spread UI 2100. In some embodiments, the digital album viewer modules 231 may be configured to distinguish between different selection modes, e.g., single-tap and double-tap, to implement context view selection and image selection features. The digital album viewer modules 231 may also be configured to distinguish between one or more additional selection modes, e.g., right-to-left swipe and left-to-right swipe, to page forward and backward among the pages of the digital album file. Alternatively, the album spread UI 2100 may be configured with page forward and page backward controls (not shown).

FIG. 22 illustrates an example client node UI in accordance with various embodiments of this disclosure. The example client node UI may be touch-interactive in some embodiments. FIG. 22 provides an album spread context-view UI that may be provided by digital album viewer modules 231 in response to a context view selection from FIG. 21. FIG. 22 includes the one or more selectable digital images 2101-2105 arranged on an album spread page 2100 as shown in FIG. 21, along with a shopping cart control 2201 (bottom left corner), an order prints control 2202, and account control 2203, and a back control 2204.

In some embodiments, the digital album viewer modules 231 may be configured to respond to a selection of the shopping cart control 2201 by displaying a shopping cart UI. The shopping cart UI may include shopping cart data structure information pertaining to pending orders, e.g., identifications of the individual images, album pages, and/or entire albums that are in the shopping cart, along with numbers of copies thereof, size/format/quality of the ordered products, costs of the ordered products and order total.

In some embodiments, the digital album viewer modules 231 may be configured to respond to a selection of the order prints control 2202 by displaying an order prints UI, e.g., as shown in FIG. 26. The displayed order prints UI may provide one or more selectable thumbnail images corresponding to images on an album page as displayed in FIG. 22. A plurality of selectable thumbnail images in the displayed order prints UI may be configured to allow ordering different sizes/variants of prints images on the album page. In some embodiments, the displayed order prints UI may provide one or more selectable thumbnail images for separately ordering each of the individual images from the album page displayed in FIG. 22—that is, from the album page from which the order prints control was selected. The selectable thumbnail images for separately ordering individual images may be in place of, or in addition to, any selectable thumbnail images for ordering prints of the album page as a whole.

In some embodiments, the digital album viewer modules 231 may be configured to respond to a selection of the account control 2203 by displaying an account management UI, as described above in connection with FIG. 19. In some embodiments, the digital album viewer modules 231 may be configured to respond to a selection of the back control 2204 by returning to a previous UI, e.g., an album spread UI as illustrated in FIG. 21.

FIG. 23A illustrates an example client node UI in accordance with various embodiments of this disclosure. The example client node UI may be touch-interactive in some embodiments. FIG. 23A provides a single-image UI that may be provided by digital album viewer modules 231 in response to a user image selection from FIG. 21 or FIG. 22. FIG. 23A includes an individual selected image 2101 occupying all or substantially all of the display, where “substantially all” in this context refers to 75% or more of the display providing the UI. FIG. 23A also includes a “close” control 2302 represented by the “x” in the top left corner, and a menu control 2303.

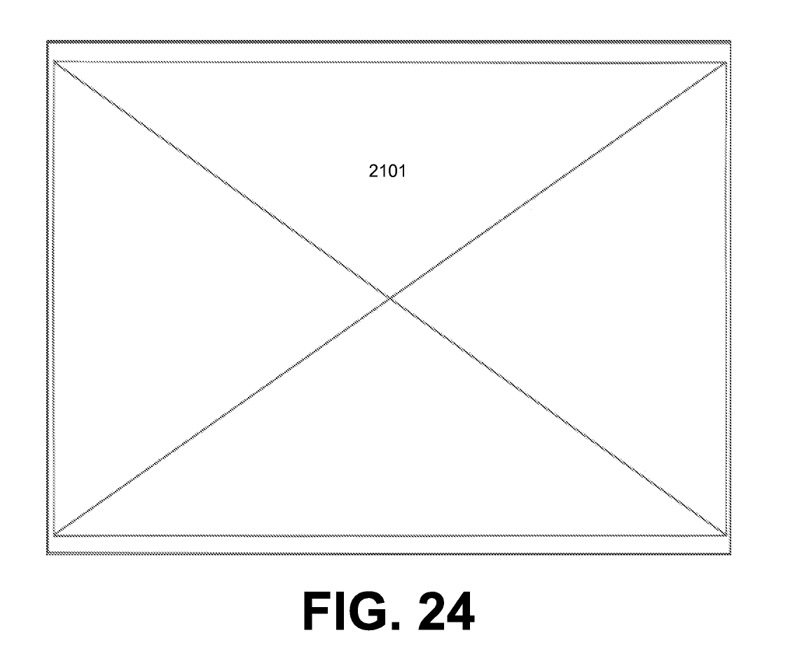

In some embodiments, the digital album viewer modules 231 may be configured to respond to a selection of the menu control 2303 by displaying an expanded menu as illustrated in FIG. 23B. Thus in the case of an individually displayed image such as in FIG. 23A, a context view selection may comprise a selection of the menu control 2303. In some embodiments, the digital album viewer modules 231 may be configured to respond to a selection of the selected image 2101, e.g., by single-tap anywhere on the single image 2101, by displaying the image 2101 in full-screen mode as illustrated in FIG. 24. Thus in the case of an individually displayed image 2101 such as in FIG. 23A, an image view selection may comprise a selection of the individually displayed image 2101. In some embodiments, the digital album viewer modules 231 may be configured to respond to a selection of the close control 2302 by returning to a previous UI, e.g., an album spread UI such as FIG. 21, from which the image displayed in FIG. 23A was selected for single-image viewing.

FIG. 23B illustrates an example client node UI in accordance with various embodiments of this disclosure. The example client node UI may be touch-interactive in some embodiments. FIG. 23B provides the single-image UI of FIG. 23A, with an expanded menu that may be provided by digital album viewer modules 231 in response to a user selection of the menu control 2303 from FIG. 23A. FIG. 23B includes the selected image 2101, close control 2302 and menu control 2303 of FIG. 23A, as well as an order prints control 2304, a share control 2305, an email control 2306, and a save control 2307.

In some embodiments, the digital album viewer modules 231 may be configured to respond to a selection of the close control 2302 as described above in connection with FIG. 23A, and to respond to a selection of the menu control 2303 by returning to a single-image UI without expanded menu options, as illustrated in FIG. 23A.

In some embodiments, the digital album viewer modules 231 may be configured to respond to a selection of the order prints control 2304 by displaying an order prints UI, e.g., as shown in FIG. 26. The displayed order prints UI may provide one or more selectable thumbnail images of a same selected image 2101 as displayed in FIG. 23B, allowing for ordering different sizes/variants of prints of the individual image.

In some embodiments, the digital album viewer modules 231 may be configured to respond to a selection of the share control 2305 by displaying an image sharing UI, similar to the album sharing UI illustrated in FIG. 20. The image sharing UI may be configured to receive recipient identifications for recipients of the individual selected image 2101, instead of recipients of an album as a whole as disclosed in connection with FIG. 20. The digital album viewer modules 231 may be configured to enable and disable the share control in FIG. 23B based on album sharing permissions for each image within a digital album. Sharing permissions may be set for individual images within a digital album file during album production, and the digital album viewer modules 231 may be configured to read a sharing permission attribute for each image within a digital album, and to enable/disable sharing controls, such as the illustrated share control 2305, based on the state of the image sharing permission attribute. Furthermore in some embodiments, the digital album viewer modules 231 may be configured to overlay a photographer's logo on top of shared image files. Overlay of photographer's logo may be optionally required by digital album file attributes assigned during the production stage.

In some embodiments, the digital album viewer modules 231 may be configured to respond to a selection of the email control 2306 by displaying an image emailing UI, which may have similar UI characteristics as the image sharing UI discussed above, but may operate differently. Instead of sending an image identification and list of recipients to the distribution server node 120, as can be done for example by the image sharing UI discussed above, the image emailing UI may be configured to create an outgoing email at the client node 130, in cooperation with any email client operable on the client node 130. The email may be addressed to recipients identified via a recipient identification field, similar to FIG. 20. The digital album viewer modules 231 may be configured to attach the selected image 2101 displayed in FIG. 23B to the email.

The digital album viewer modules 231 may also be configured to enable and disable the email control 2306 in FIG. 23B based on email permissions for each image within a digital album. Emailing permissions may be set for individual images within a digital album file during album production, and the digital album viewer modules 231 may be configured to read an email permission attribute for each image within a digital album, and to enable/disable email controls, such as the illustrated email control 2306, based on the state of the email permission attribute. In some embodiments, the digital album viewer modules 231 may be configured to overlay a photographer's logo on top of emailed image files, as may optionally be required by digital album file attributes assigned during the production stage.

In some embodiments, the digital album viewer modules 231 may be configured to respond to a selection of the save control 2307 by saving the individual selected image 2101 displayed in FIG. 23B to a memory location accessible by the client node 130, such as a main disk, flash, or other non-volatile memory location used by the client node 130. In some embodiments, the digital album viewer modules 231 may be configured to display a file save UI configured to allow a user to specify a desired file name and directory location for the file. In some embodiments, the file save UI may specify a default directory location and/or a default file name.

The digital album viewer modules 231 may also be configured to enable and disable the save control 2307 in FIG. 23B based on save permissions for each image within a digital album. Save permissions may be set for individual images within a digital album file during album production, and the digital album viewer modules 231 may be configured to read a save permission attribute for each image within a digital album, and to enable/disable save controls, such as the illustrated save control 2307, based on the state of the save permission attribute. In some embodiments, the digital album viewer modules 231 may be configured to overlay a photographer's logo on top of saved image files, as may optionally be required by digital album file attributes assigned during the production stage.

In some embodiments, the digital album viewer modules 231 may be configured to display an album cover and album cover controls, e.g., in response to selection of an album from the album library illustrated in FIG. 19, in multiple interaction modes comprising a “normal” mode and a “context view” mode similarly to display of an album spread page as illustrated in FIG. 21 and FIG. 22, and display of an individual image as illustrated in FIG. 23A and FIG. 23B. Touch-interactive controls available from the album cover may be configured for operations involving a digital album as a whole, e.g., ordering an album as a whole, sharing an invitation to an album as a whole, emailing an invitation to view an album as a whole, and so on as described herein. Also, a guest book control may be available from the album cover.

FIG. 24 illustrates an example client node UI in accordance with various embodiments of this disclosure. The example client node UI may be touch-interactive in some embodiments. FIG. 24 provides a full-screen single-image UI comprising selected image 2101 that may be provided by digital album viewer modules 231 in response to a user indication from FIG. 23A or FIG. 23B. The full-screen single-image UI occupies all of a client node 130 display, and is characterized by the omission of the close control 2302 and menu controls 2303-2307 illustrated in FIG. 23A and FIG. 23B.

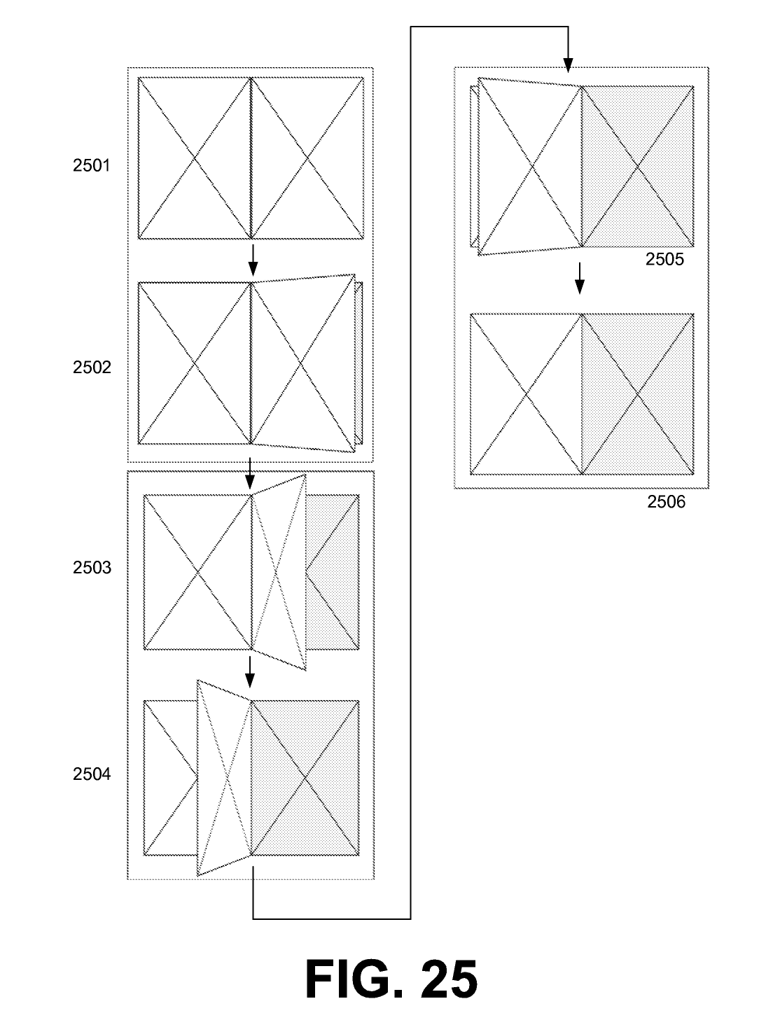

FIG. 25 illustrates an example display sequence indicating navigation between pages/spreads of a digital album in accordance with various embodiments of this disclosure. In some embodiments, digital album viewer modules 231 may be configured to display a page flip sequence such as illustrated in steps 2501-2506, in response to a user spread navigation input. In step 2501, an original album spread is displayed. In step 2501, a next album spread is displayed. In each of steps 2502-2505, transitional spread views are displayed, simulating a page turn from the original album spread to the next album spread. Steps 2501-2506 may also be displayed in reverse to navigate to previous album pages. In some embodiments, spread navigation inputs for forward or reverse navigation between spreads may comprise right-to-left swipes on a touch screen, left-to-right swipes, and/or single taps on a right or left side of a touch screen. In some embodiments, a page flip sequence such as illustrated in steps 2501-2506 may also be displayed for navigation to and from an album cover.

FIG. 26 illustrates an example client node UI in accordance with various embodiments of this disclosure. The example client node UI may be touch-interactive in some embodiments. FIG. 26 provides a first order prints UI that may be provided by digital album viewer modules 231 in response to selection of the order prints control in FIG. 22 or FIG. 23B. FIG. 26 includes one or more selectable print order controls 2601, 2602, 2603, represented in FIG. 26 by the small, medium, and large size boxes. The selectable print order controls 2601, 2602, 2603 may include thumbnail images, e.g. images to be ordered by selection of a corresponding print order control. FIG. 26 also includes a more products control 2604, an order total, a cancel control 2605, and an account access control 2606 (represented in FIG. 26 by the small icon in the UI title bar showing a person's head and shoulders).

In some embodiments, the digital album viewer modules 231 may be configured to respond to a selection of any of the print order controls 2601, 2602, 2603 by adding corresponding order information to a shopping cart data structure. For example, each time the 4×6 print order control 2601 is selected, the digital album viewer modules 231 may increment order information in a shopping cart data structure for example by adding one additional image, of a size corresponding to the selected control (in this case, 4×6) in the shopping cart data structure. The digital album viewer modules 231 may furthermore add the price of the corresponding image (e.g., the price of a 4×6 is $5.00) to an order total in a shopping cart data structure, which order total may be displayed in the first order prints UI. The prices displayed in FIG. 26-FIG. 28 may be set by reference to print sales configuration data provided with a digital album, or may be otherwise acquired from the distribution server node 120. The shopping cart data structure may be in a memory location at the client node 130 and/or at the distribution server node 120. The digital album viewer modules 231 may furthermore display a remove control and number of ordered products, discussed below with reference to FIG. 27, for any of the print order controls 2601, 2602, 2603 having a non-zero number of orders in the shopping cart data structure.

In some embodiments, the digital album viewer modules 231 may be configured to respond to a selection of the more products control 2604 by displaying additional product order controls, discussed below with reference to FIG. 27. The digital album viewer modules 231 may be configured to respond to a selection of the cancel control 2605 by returning to a previously displayed image or album page. The digital album viewer modules 231 may be configured to respond to a selection of the account access 2606 control by displaying an account management UI, as described above in connection with FIG. 19.

FIG. 27 illustrates an example client node UI in accordance with various embodiments of this disclosure. The example client node UI may be touch-interactive in some embodiments. FIG. 27 provides a second order prints UI that may be provided by digital album viewer modules 231 in response to selection of a print order control in FIG. 26. FIG. 27 includes the print order controls 2601, 2602, 2603, more products control 2604, order total, cancel control 2605, and account access control 2606 of FIG. 26. FIG. 27 also includes a shopping cart control 2201, a finalize order control 2701 (top right), a remove control 2702, and a number of ordered products 2703 associated with one of the print order controls 2601, 2602, 2603. FIG. 27 also includes additional product order controls, including an albums control 2704, a showcase control 2705, a specialty control 2706, and a prints control 2703.

In some embodiments, the digital album viewer modules 231 may be configured to respond to a selection of the print order controls 2601, 2602, 2603, cancel control 2605, and account access control 2606 as described above with reference to FIG. 26. The digital album viewer modules 231 may be configured to respond to a selection of the more products control 2604 in FIG. 27 by toggling to a collapsed view which does not include the additional product order controls 2703-2706, as shown in FIG. 26.

In some embodiments, the digital album viewer modules 231 may be configured to respond to a selection of a remove control 2702 for example by removing one order of a corresponding image, of the size corresponding to the selected control (in this case, 4×6) in the shopping cart data structure. For example, each time the 4×6 remove control 2702 is selected, the digital album viewer modules 231 may decrement order information in the shopping cart data structure by subtracting one image (or album page), of a size corresponding to the selected control (in this case, 4×6). The digital album viewer modules 231 may furthermore subtract the price of the corresponding image (e.g., the price of a 4×6 is $5.00) from an order total in a shopping cart data structure, which order total may be displayed in the second order prints UI. The digital album viewer modules 231 may furthermore update the displayed number of ordered products associated with one of the print order controls 2601, 2602, 2603. The digital album viewer modules 231 may furthermore optionally omit remove controls 2702 from the second order prints UI, for any of the print order controls 2601, 2602, 2603 having zero orders in the shopping cart data structure. For example, the 5×7 and 8×10 sizes are not associated with any orders in the example of FIG. 27, and therefore no remove control is displayed for controls 2602 and 2603.

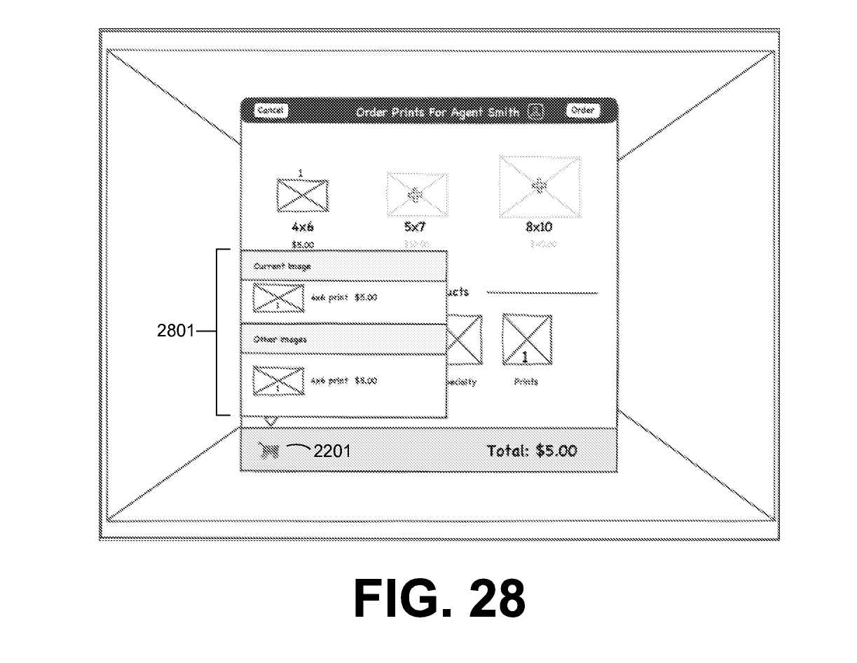

In some embodiments, the digital album viewer modules 231 may be configured to respond to a selection of a shopping cart control 2201 by displaying a third order prints UI, discussed below with reference to FIG. 28. In some embodiments, the digital album viewer modules 231 may be configured to respond to a selection of a finalize order control 2701 by displaying a buyer information UI, discussed below with reference to FIG. 29, if a user is not logged in, or an order approval UI, discussed below with reference to FIG. 33, if a user is logged in.

In some embodiments, the digital album viewer modules 231 may be configured to respond to a selection of any of the additional product order controls 2703-2706 including an albums control 2704, a showcase control 2705, a specialty control 2706, and a prints control 2303, by displaying one or more UI including controls for ordering such additional products. The digital album viewer modules 231 may be configured to respond to selection of the albums control 2704 by providing a UI comprising controls for incrementing a number of entire albums in the shopping cart data structure. The albums orderable from the albums control 2704 in FIG. 27 may be limited to the album containing the images which are orderable from the first and second order prints UI, or may optionally include other albums in a user's album library. In some embodiments, the digital album viewer modules 231 may be configured to display a number of ordered products within the shopping cart data structure, for each of the additional product order controls 2703-2706. For example, in FIG. 27, it can be seen that the shopping cart data structure includes an order for 1 print, while it does not include orders for any albums, showcase, or specialty items.

FIG. 28 illustrates an example client node UI in accordance with various embodiments of this disclosure. The example client node UI may be touch-interactive in some embodiments. FIG. 28 provides a third order prints UI that may be provided by digital album viewer modules 231 in response to selection of a shopping cart control 2201 in FIG. 27. FIG. 28 includes various aspects of FIG. 27, along with a shopping cart summary 2801. The shopping cart summary 2801 includes number(s) and type(s) of ordered products corresponding to a current product (such as an image) that is orderable from the third order prints UI, and number(s) and type(s) of other ordered products within the shopping cart data structure. For example, FIG. 28 illustrates that 14×6 print of a current product (in this case, an image) is in the shopping cart data structure, and 14×6 print of another product (in this case, also an image) is in the shopping cart data structure. Each of the products may be identified by a thumbnail image as well as text description.

FIG. 29 illustrates an example client node UI in accordance with various embodiments of this disclosure. The example client node UI may be touch-interactive in some embodiments. FIG. 29 provides a buyer information UI that may be provided by digital album viewer modules 231 in response to selection of a finalize order control 2701 in FIG. 27 or FIG. 28, and/or in response to selection of the “my first order” control 2901 in FIG. 29. FIG. 29 includes a “my first order” control 2901, a “returning customer” control 2902, an email field 2903, a full name field 2904, an order total, a cancel control 2906 and a continue control 2905.

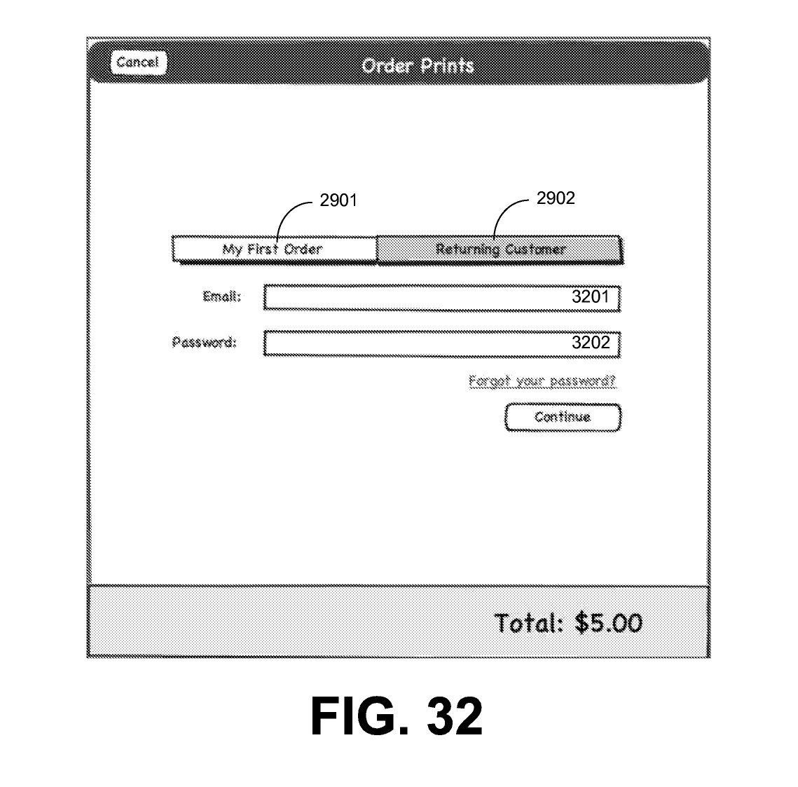

In some embodiments, the digital album viewer modules 231 may be configured to respond to a selection of the “my first order” control 2901 by displaying the email field 2903 and full name field 2904 as shown in FIG. 29. The digital album viewer modules 231 may be configured to respond to a selection of the returning customer control 2902 by displaying the returning customer login for ordering prints UI of FIG. 32. The digital album viewer modules 231 may be configured to display an order total from the shopping cart data structure. The digital album viewer modules 231 may be configured to respond to a selection of the cancel control 2906 by returning to an order prints UI such as FIG. 26 or FIG. 27.

In some embodiments, the digital album viewer modules 231 may be configured to receive an email identification via the email field 2903, and a full name identification via the full name field 2904. The digital album viewer modules 231 may be configured to save a received email identification and full name identification in a shopping cart data structure, in response to selection of the continue control 2905. The digital album viewer modules 231 may be configured to also save a received email identification and full name identification to a user profile data structure, for use with any subsequent orders made from the client node 130. The user profile data structure may be in a memory location at the client node 130 and/or at the server node 120.

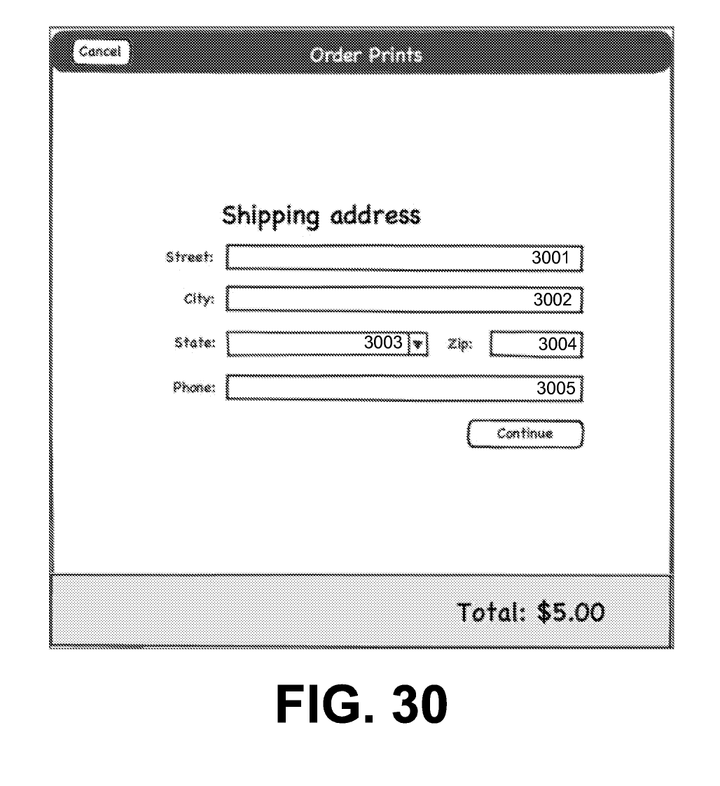

FIG. 30 illustrates an example client node UI in accordance with various embodiments of this disclosure. The example client node UI may be touch-interactive in some embodiments. FIG. 30 provides a shipping address UI that may be provided by digital album viewer modules 231 in response to selection of a continue control in FIG. 29. FIG. 30 includes shipping address fields including a street field 3001, city field 3002, state selection field 3003, zip code field 3004, and telephone number field 3005. FIG. 30 also includes a cancel control, an order total and a continue control. The digital album viewer modules 231 may be configured to respond to a selection of the cancel control by returning to an order prints UI such as FIG. 26 or FIG. 27.

In some embodiments, the digital album viewer modules 231 may be configured to receive street, city, state, zip code, and telephone number identifications via the street field, city field, state selection field, zip code field, and telephone number field, respectively. The digital album viewer modules 231 may be configured to save the received identifications in a shopping cart data structure, in response to selection of the continue control. The digital album viewer modules 231 may be configured to save received identifications to a user profile data structure, for use with any subsequent orders made from the client node 130.

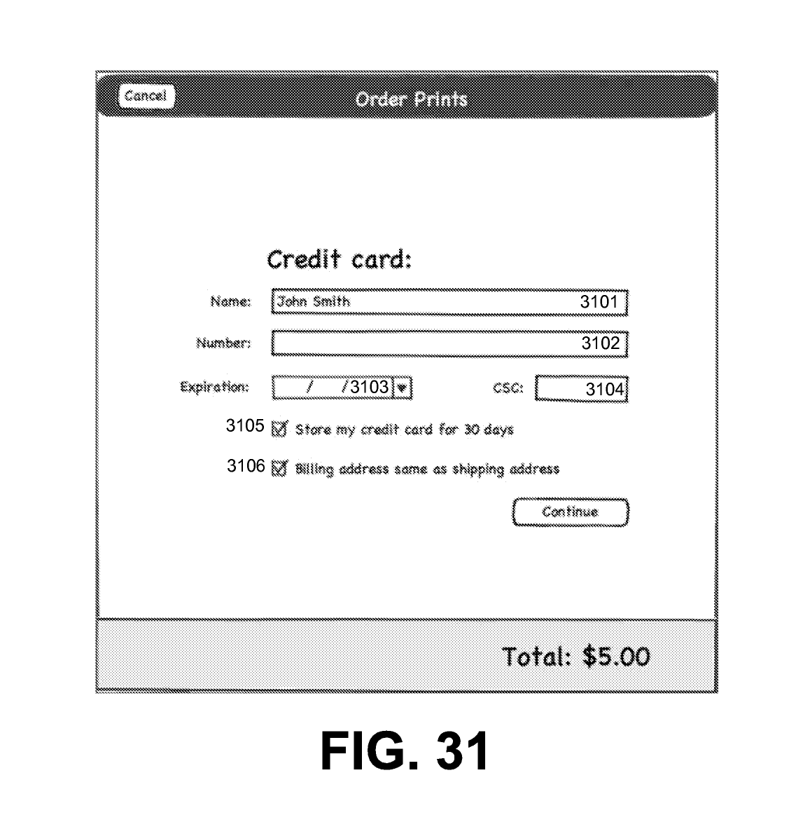

FIG. 31 illustrates an example client node UI in accordance with various embodiments of this disclosure. The example client node UI may be touch-interactive in some embodiments. FIG. 31 provides a credit card UI that may be provided by digital album viewer modules 231 in response to selection of a continue control in FIG. 30. FIG. 31 includes credit card information fields including a credit card name field 3101, a credit card number field 3102, a credit card expiration date field 3103, a credit card security code (CSC) field 3104, and one or more billing address fields (not shown). FIG. 31 may also include a selectable flag granting permission to store credit card information 3105, and selectable flag for indicating that credit card billing address is the same as the shipping address 3106. FIG. 30 also includes a cancel control, an order total and a continue control.

In some embodiments, the digital album viewer modules 231 may be configured to receive credit card name, a credit card number, credit card expiration date, CSC, and billing address identifications via the credit card name field, a credit card number field, a credit card expiration date field, a credit card security code (CSC) field, and one or more billing address fields, respectively. The digital album viewer modules 231 may be configured to save the received identifications in a shopping cart data structure, in response to selection of the continue control. The digital album viewer modules 231 may be configured to save received identifications to a user profile data structure, for use with any subsequent orders made from the client node 130, when the selectable flag granting permission to store credit card information is checked, and/or in response to selection of the continue control. The digital album viewer modules 231 may be configured to use shipping address identifications as billing address identifications, or vice versa, when the selectable flag indicating that credit card billing address is the same as the shipping address is checked. The digital album viewer modules 231 may be configured to respond to a selection of the cancel control by returning to an order prints UI such as FIG. 26 or FIG. 27.

FIG. 32 illustrates an example client node UI in accordance with various embodiments of this disclosure. The example client node UI may be touch-interactive in some embodiments. FIG. 32 provides a returning customer login for ordering prints UI that may be provided by digital album viewer modules 231 in response to selection of a finalize order control in FIG. 27 or 28, and/or in response to selection of a returning customer control 2902 in FIG. 29 or FIG. 32. FIG. 32 includes an email field 3201, a password field 3202, a “forgot your password?” control, an order total and a continue control.

It should be noted that when a user has previously logged in, for example via the interfaces provided in FIG. 16 or FIG. 17, and when user profile data already includes shipping and credit card billing information, the digital album viewer modules 231 may be configured to skip the UI and corresponding method steps of FIGS. 29, 30, 31, and 32, and may proceed directly to the order approval UI illustrated in FIG. 33.

In some embodiments, the digital album viewer modules 231 may be configured to receive an email identification via the email field 3201, and to receive a password identification via the password field 3202. In response to selection of the continue control, a logon module among the album viewer modules 231 may compare the received email and password identifications to stored email/password combinations associated with user accounts, and if there is a match, to retrieve user account information from the matching account as necessary to provide an order approval UI such as FIG. 33. In some embodiments, the logon process may be made in conjunction with a distribution server node 120, e.g., by sending received email and password identifications to the distribution server node 120, and receiving user account data back from the distribution server node 120. In some embodiments, the digital album viewer modules 231 may be configured to perform the logon process locally at the client node 130, by comparing received email and password identifications to user account logon information stored locally at the client node 130.

In some embodiments, the digital album viewer modules 231 may be configured to provide a lost password UI in response to selection of the “forgot your password?” control. The lost password UI may request an email address for emailing the forgotten password by the distribution server node 120. The digital album viewer modules 231 may be configured to respond to a selection of the cancel control by returning to an order prints UI such as FIG. 26 or FIG. 27.

FIG. 33 illustrates an example client node UI in accordance with various embodiments of this disclosure. The example client node UI may be touch-interactive in some embodiments. FIG. 33 provides an order approval UI that may be provided by digital album viewer modules 231 in response to selection of a continue control in FIG. 31 or FIG. 32. FIG. 33 includes shipping address and shipping address change control 3301, a credit card number and credit card number change control 3302, a cancel control, an order total and a complete order control 3303.

In some embodiments, the digital album viewer modules 231 may be configured to provide a shipping address UI such as FIG. 30 in response to selection of the shipping address change control 3301. The digital album viewer modules 231 may be configured to provide a credit card UI such as FIG. 31 in response to selection of the credit card number change control 3302.

In some embodiments, the digital album viewer modules 231 may be configured to respond to a selection of the complete order control 3303 by sending order information to the distribution server node 120. In some embodiments, the order information may comprise a shopping cart data structure including product identifications and numbers of units of each ordered product, and/or an order total. In some embodiments, the order information may comprise user profile information such as user name, shipping address, and credit card information. In embodiments in which the shopping cart data structure and/or user profile data structure exist at the distribution server node 120, the order information may comprise an order instruction. In some embodiments, the digital album viewer modules 231 may be configured to respond to a selection of the complete order control 3303 by also saving order information to an order history data structure. The order history data structure may for example provide a portion of a user profile data structure and may include order dates, order totals, and order details such as order shipping address, product identifications of ordered products and number of units of ordered products.

In some embodiments, the digital album viewer modules 231 may be configured to respond to a selection of the cancel control by returning to an order prints UI such as FIG. 26 or FIG. 27.

FIG. 34 illustrates an example client node UI in accordance with various embodiments of this disclosure. The example client node UI may be touch-interactive in some embodiments. FIG. 32 provides a create account password UI that may be provided by digital album viewer modules 231 in response to selection of a continue control in FIG. 33. FIG. 34 includes an account email display, a password entry field 3401, and also includes a cancel control, an order total and a continue (next) control.

In some embodiments, the digital album viewer modules 231 may be configured to display an account email by retrieving an email from a stored user profile data structure and/or from a shopping cart data structure. The digital album viewer modules 231 may be configured to receive a password identification via the password entry field 3401. The digital album viewer modules 231 may be configured to respond to selection of the continue control by storing the received password identification in a user profile data structure at the client node 130, and otherwise configuring a logon module to require the password for subsequent access to stored user profile and user account information such as user profile data, albums, and order history information. The digital album viewer modules 231 may be configured to respond to a selection of the cancel control by returning to an order prints UI such as FIG. 26 or FIG. 27. Also, the digital album viewer modules 231 may be configured to skip the UI of FIG. 33 and FIG. 34 when a user is currently logged in.

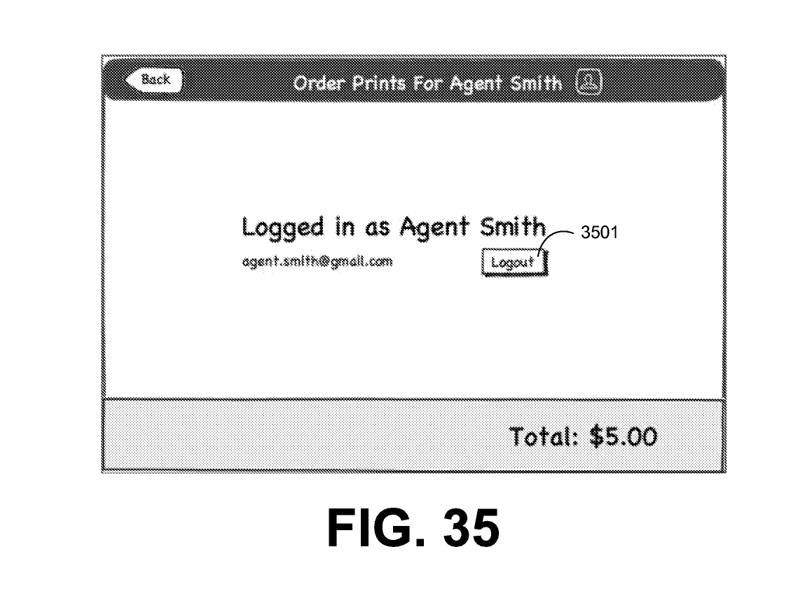

FIG. 35 illustrates an example client node UI in accordance with various embodiments of this disclosure. The example client node UI may be touch-interactive in some embodiments. FIG. 35 provides a login status UI that may be provided by digital album viewer modules 231 in response to selection of a continue (next) control in FIG. 34. FIG. 35 includes a login notification, an account name/account email display, a logout control 3501, an order total, a back control and the account access control of FIG. 26

In some embodiments, the digital album viewer modules 231 may be configured to respond to selection of the logout control 3501 by logging out of a current login session, resulting in discontinuing (blocking) access to stored user profile and user account information such as user profile data, albums, and order history information pursuant to a logout process, and optionally shutting down the digital album viewer application. In some embodiments, the digital album viewer modules 231 may be configured to respond to selection of the back control by returning to a previous UI such as, for example, an album library UI as illustrated in FIG. 19.

While various embodiments have been disclosed herein, other aspects and embodiments will be apparent to those skilled in art, with the benefit of this disclosure.

1. A digital album client node device configured to view touch-interactive digital albums, comprising:
a processor;
a memory;
a touch-screen display; and
digital album viewer modules configured to:
display a touch-interactive digital album on the touch-screen display;
display album spreads within the digital album on the touch-screen display in response to touch spread navigation inputs on the touch-screen display, wherein each album spread comprises one or more digital images at custom defined positions within the album spread;
individually display a selected image from an album spread on the touch-screen display in response to a touch image selection input on the touch-screen display;
display touch-interactive controls with the selected image on the touch-screen display, the touch-interactive controls comprising one or more of an order prints control, a share image control, an email image control, and a save image control; and
display on the touch-screen display a touch interactive order prints User Interface (UI), a touch interactive share image UI, a touch interactive email image UI, or a touch interactive save image UI, configured to order prints of the selected image, share the selected image via a social media website, email the selected image, and save the selected image to the memory, respectively, in response to a touch selection of the order prints control, share image control, email image control, or save image control.

2. The digital album client node device of claim 1, wherein the digital album viewer modules are configured to display the touch-interactive digital album on the touch-screen display in response to a touch selection of the digital album on the touch-screen display.

3. The digital album client node device of claim 2, wherein the digital album viewer modules are configured to display a touch interactive album library on the touch-screen display comprising one or more touch-interactive digital albums available to a user of the digital album client node device, and wherein the touch interactive album library is configured to receive the touch selection of the digital album.

4. The digital album client node device of claim 1, wherein the digital album viewer modules are configured to display on the touch-screen display a page flip sequence in response to a touch spread navigation input.

5. The digital album client node device of claim 1, wherein the digital album viewer modules are configured to display a touch-interactive guestbook access control with the digital album, and to display a touch interactive guestbook UI in response to a touch selection of the guestbook control.

6. The digital album client node device of claim 1, wherein the digital album viewer modules are configured to:
display touch-interactive controls with the digital album comprising one or more of an order album control, a share album control, an email album control, and a save album control; and
display touch interactive order album UI, a touch interactive share album UI, a touch interactive email album UI, or a touch interactive save album UI, configured to order a printed digital album as a whole, share an invitation to view the digital album via a social media website, email an invitation to view the digital album, and save the digital album to the memory, respectively, in response to a touch selection of the order album control, share album control, email album control, or save album control.

7. The digital album client node device of claim 1, wherein the digital album viewer modules are configured to display the touch-interactive controls with the selected image in response to a context-view input on the selected image on the touch-screen display.

8. The digital album client node device of claim 1, wherein the digital album viewer modules are configured to display touch-interactive controls with the selected image that are allowed for the selected image in album properties associated with the digital album.

9. The digital album client node device of claim 1, wherein the digital album viewer modules are configured to detect a client node device type, and to default to either a spread-by-spread view of the digital album or an image-by-image view of the digital album in response to the detected client node device type.

10. The digital album client node device of claim 1, wherein the digital album viewer modules are configured to provide a touch-interactive album finder that is configured to receive album identification information and send the album identification information to a distribution server node.

11. A digital album client node device, comprising:
a processor;
a memory;
a display; and
digital album viewer modules comprising:
an album library view handler configured to display an album library User Interface (UI) on the display, the album library UI comprising selectable cover images of digital album files, the digital album files each comprising an album cover image and one or more album spreads, each album spread comprising one or more digital images, and each digital image having a defined position within an album spread;
a spread context-view handler configured to display a spread context-view UI on the display, the spread context-view UI comprising an album spread from a selected digital album file, including one or more digital images at their defined positions within the album spread;
wherein the spread context-view handler is further configured to display an order spread prints control, and to respond to selection of the order spread prints control by providing an order prints UI that is configured to receive orders of images displayed within an album spread;
wherein the spread context-view handler is further configured to receive a selection of any of the one or more digital images within a displayed album spread and to respond to selection of a digital image within a displayed album spread by providing a single-image UI comprising a selected digital image;
a single-image view handler configured display a single-image UI on the display, the single-image UI comprising a single digital image from a selected digital album file, and further configured to display single-image interaction controls comprising an order image prints control, a image sharing control, and a save image control;
wherein the single-image view handler is configured to respond to a selection of the order image prints control by displaying an order prints UI that is configured to receive print orders of a displayed single digital image;
wherein the single-image view handler is configured to respond to a selection of the image sharing control by displaying image sharing UI that is configured to receive recipient identifications of one or more sharing recipients a displayed single digital image;
wherein the single-image view handler is configured to respond to a selection of the save image control by saving a displayed single digital image in the memory.

12. The digital album client node device of claim 11, wherein the single-image view handler is configured to check interaction permission settings in digital album files, and to enable and disable one or more of the interaction controls in the single-image UI according to the interaction permission settings.

13. The digital album client node device of claim 11, wherein the digital album viewer modules comprise distribution server node communication modules configured to send and receive album identification data, digital album files, album interaction data, and order information between the client node device and a pre-designated distribution server node.

14. The digital album client node device of claim 11, wherein the digital album viewer modules include an account manager configured to receive, store, and subsequently modify user profile data.

15. The digital album client node device of claim 11, wherein the digital album viewer modules include a display manager configured to detect a client node device type, and to set view setting to either a spread-by-spread view setting or an image-by-image view setting, based on a detected device type.

16. The digital album client node device of claim 11, wherein one or more of the order prints UI includes a plurality of differently sized print order controls, each print order control comprising a selectable thumbnail of a digital image that is orderable using the print order control, and wherein a size of a print order control corresponds to a size of a digital image to be ordered using the print order control.

17. The digital album client node device of claim 11, wherein one or more of the order prints UI includes an album order control configured to place an order for an entire digital album.

18. The digital album client node device of claim 11, wherein the digital album viewer modules further comprise an album sharing control configured to receive recipient identifications of one or more sharing recipients an entire digital album file.

19. The digital album client node device of claim 18, wherein the digital album viewer modules are configured to check interaction permission settings in digital album files, and to enable and disable the album sharing control according to an interaction permission setting.

20. The digital album client node device of claim 11, wherein the digital album viewer modules further comprise an album finder configured to receive album identification information, and wherein the digital album viewer modules are configured to send the album identification information to a distribution server node.
